(19) United States
(12) Patent Application Publication
(10) Pub. No.: US 2017/0344925 A1
(43) Pub. Date: Nov. 30, 2017

(54) TRANSMISSION OF MESSAGES BASED ON THE OCCURRENCE OF WORKFLOW EVENTS AND THE OUTPUT OF PROPENSITY MODELS IDENTIFYING A FUTURE FINANCIAL REQUIREMENT

(71) Applicants: Eva Diane Chang, Mountain View, CA (US); Madhu Shalini Iyer, Fremont, CA (US); Jeffrey Lewis Kaufman, Mountain View, CA (US)

(72) Inventors: Eva Diane Chang, Mountain View, CA (US); Madhu Shalini Iyer, Fremont, CA (US); Jeffrey Lewis Kaufman, Mountain View, CA (US)

(73) Assignee: Intuit Inc., Mountain View, CA (US)

(21) Appl. No.: 15/169,728

(22) Filed: May 31, 2016

(51) Int. Cl. G06Q 10/06

(52) U.S. Cl. CPC G06Q 10/06315; G06Q 10/067

(57) ABSTRACT

A method for transmitting messages based on the occurrence of workflow events and the output of propensity models identifying a future financial requirement. The method includes generating, based on a propensity model score of a business entity, a classification of a future financial requirement of the business entity. Also, the method includes determining that the classification of the future financial requirement of the business entity meets a financial requirement threshold. Further, the method includes determining, using data of the business entity, that an aspect of the business entity meets a business activity threshold. Moreover, the method includes detecting that a workflow event has occurred on a platform utilized by the business entity. Still yet, the method includes, in response to the determination that the workflow event has occurred, transmitting a message to a user of the business entity.

### CROSS-REFERENCE TO RELATED APPLICATIONS

This application is related to: U.S. patent application Ser. No. 15/143,499, filed Apr. 29, 2016, entitled “PROPENSITY MODEL FOR DETERMINING A FUTURE FINANCIAL REQUIREMENT”; U.S. patent application Ser. No. 15/143,485, filed Apr. 29, 2016, entitled “USER DATA AUGMENTED PROPENSITY MODEL FOR DETERMINING A FUTURE FINANCIAL REQUIREMENT”; U.S. patent application Ser. No. ______, filed MONTH DAY, 2016, entitled “EXTERNALLY AUGMENTED PROPENSITY MODEL FOR DETERMINING A FUTURE FINANCIAL REQUIREMENT”; U.S. patent application Ser. No. ______, filed MONTH DAY, 2016, entitled “APPLICATION OF MULTIPLE PROPENSITY MODELS FOR IDENTIFYING A FUTURE FINANCIAL REQUIREMENT”; U.S. patent application Ser. No. ______, filed MONTH DAY, 2016, entitled “APPLICATION OF MULTIPLE EXTERNALLY AUGMENTED PROPENSITY MODELS FOR IDENTIFYING A FUTURE FINANCIAL REQUIREMENT”; and U.S. patent application Ser. No. ______, filed MONTH DAY, 2016, entitled “TRANSMISSION OF A MESSAGE BASED ON THE OCCURRENCE OF A WORKFLOW EVENT AND THE OUTPUT OF AN EXTERNALLY AUGMENTED PROPENSITY MODEL IDENTIFYING A FUTURE FINANCIAL REQUIREMENT”.

### BACKGROUND

For growing businesses, access to financial resources is key to continue or increase growth. However, many growing businesses fail to appreciate that continued growth will likely put them in a position of financial need sometime in the near future. Thus, by the time many growing businesses initiate a process to obtain financing, they are at a disadvantage. For example, the process of applying for and obtaining a low interest rate business loan can be a burdensome and protracted experience. Consequently, a growing business may be forced to choose between a higher interest rate short-term loan, or stunting continued business growth by delaying some business activities until a lower interest rate loan can be obtained.

### SUMMARY

In general, in one aspect, the invention relates to a method for transmitting messages based on the occurrence of workflow events and the output of propensity models identifying a future financial requirement. The method includes generating, based on a propensity model score of a business entity, a classification of a future financial requirement of the business entity. Also, the method includes determining that the classification of the future financial requirement of the business entity meets a financial requirement threshold. Further, the method includes determining, using data of the business entity, that an aspect of the business entity meets a business activity threshold. Moreover, the method includes detecting that a workflow event has occurred on a platform utilized by the business entity. Still yet, the method includes, in response to the determination that the workflow event has occurred, transmitting a message to a user of the business entity.

In general, in one aspect, the invention relates to a system for transmitting messages based on the occurrence of workflow events and the output of propensity models identifying a future financial requirement. Also, the system includes software instructions stored in the memory. The software instructions are configured to execute on the hardware processor, and, when executed by the hardware processor, cause the hardware processor to generate, based on a propensity model score of a business entity, a classification of a future financial requirement of the business entity. Also, when executed by the hardware processor, the software instructions cause the hardware processor to determine that the classification of the future financial requirement of the business entity meets a financial requirement threshold. Further, when executed by the hardware processor, the software instructions cause the hardware processor to determine, using data of the business entity, that an aspect of the business entity meets a business activity threshold. In addition, when executed by the hardware processor, the software instructions cause the hardware processor to detect that a workflow event has occurred on a platform utilized by the business entity. Moreover, when executed by the hardware processor, the software instructions cause the hardware processor to, in response to the determination that the workflow event has occurred, transmit a message to a user of the business entity.

In general, in one aspect, the invention relates to a non-transitory computer readable medium for transmitting messages based on the occurrence of workflow events and the output of propensity models identifying a future financial requirement. The non-transitory computer readable medium stores instructions which, when executed by a computer processor, comprise functionality for generating, based on a propensity model score of a business entity, a classification of a future financial requirement of the business entity. Also, the non-transitory computer readable medium stores instructions which, when executed by the computer processor, comprise functionality for determining that the classification of the future financial requirement of the business entity meets a financial requirement threshold. Further, the non-transitory computer readable medium stores instructions which, when executed by the computer processor, comprise functionality for determining, using data of the business entity, that an aspect of the business entity meets a business activity threshold. Additionally, the non-transitory computer readable medium stores instructions which, when executed by the computer processor, comprise functionality for detecting that a workflow event has occurred on a platform utilized by the business entity. Still yet, the non-transitory computer readable medium stores instructions which, when executed by the computer processor, comprise functionality for, in response to the determination that the workflow event has occurred, transmitting a message to a user of the business entity.

Other aspects and advantages of the invention will be apparent from the following description and the appended claims.

### BRIEF DESCRIPTION OF DRAWINGS

FIGS. 1A, 1B, 1C, and 1D illustrate systems in accordance with one or more embodiments of the invention.

FIGS. 2A, 2B, 2C, and 2D illustrate methods performed in accordance with one or more embodiments of the invention.

FIGS. 3A and 3B illustrate methods of providing financing offers based on the occurrence of a workflow event and the output of a propensity model, in accordance with one or more embodiments of the invention.

FIGS. 4A, 4B, and 4C illustrate system drawings showing the transmission of a financing offer based on the output of one or more propensity models and the occurrence of a workflow event, in accordance with one or more embodiments of the invention.

FIG. 5A shows a computing system, in accordance with one or more embodiments of the invention.

FIG. 5B shows a group of computing systems, in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In the following description, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

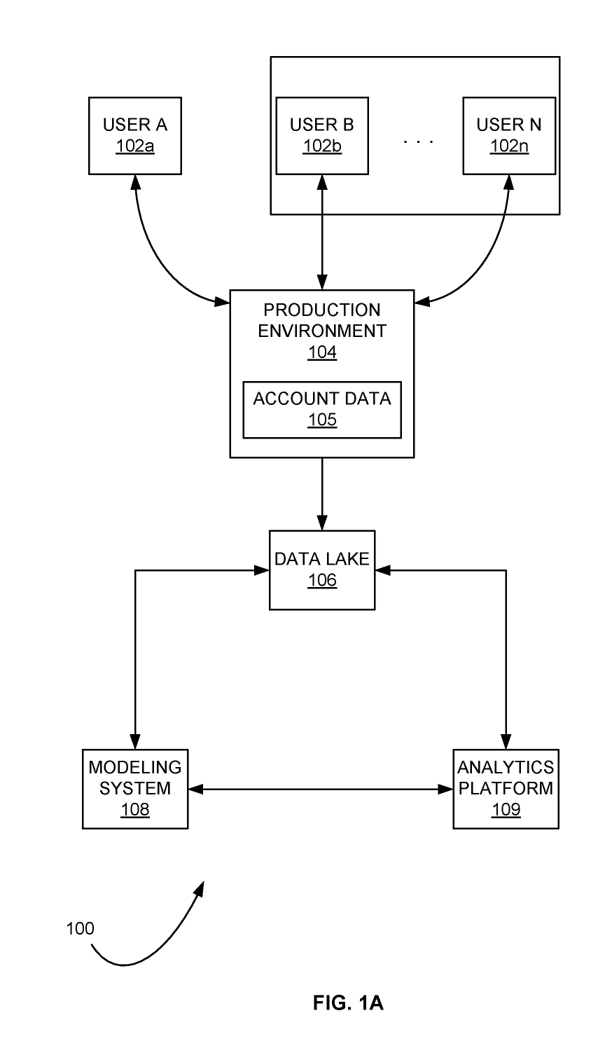

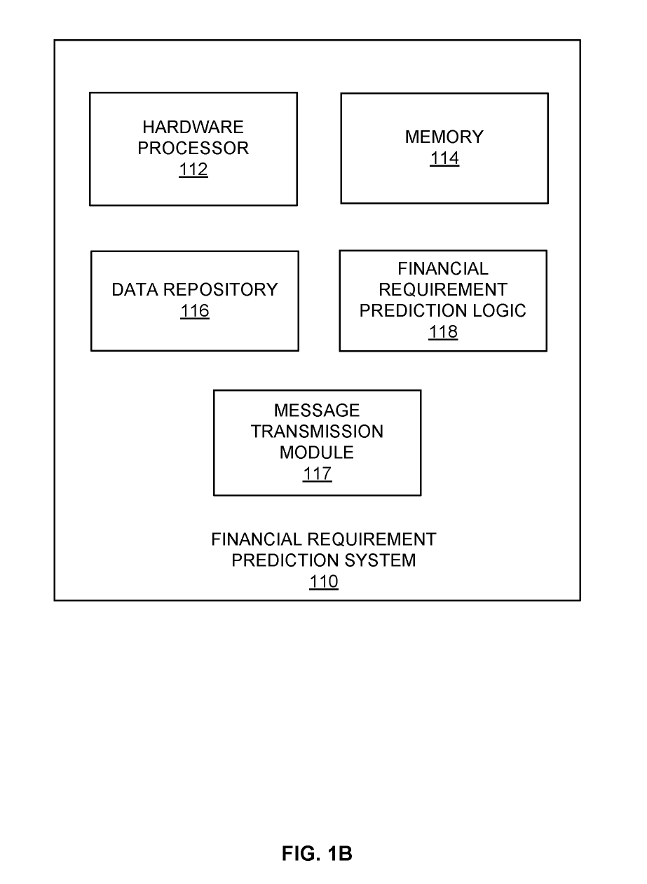

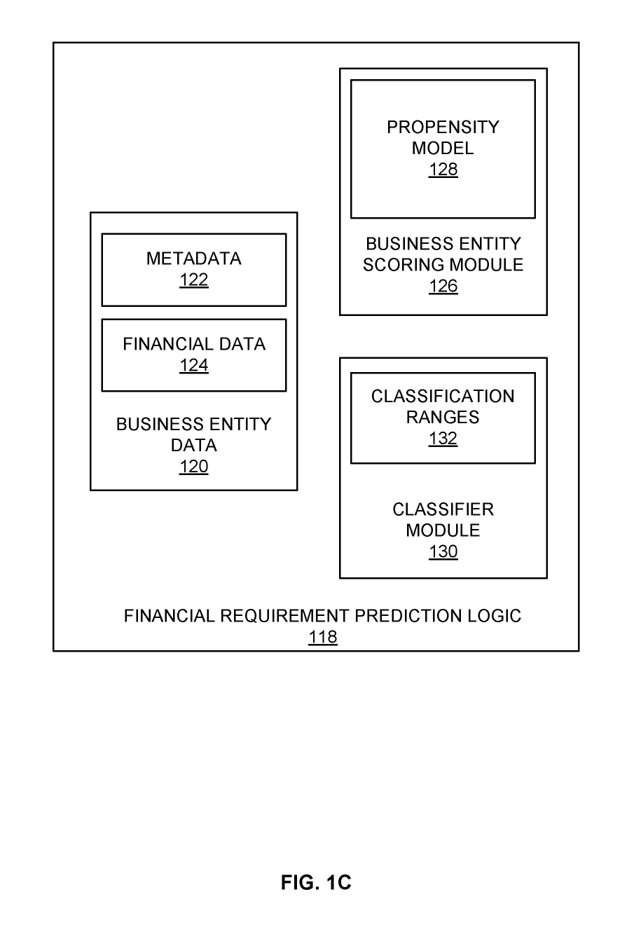

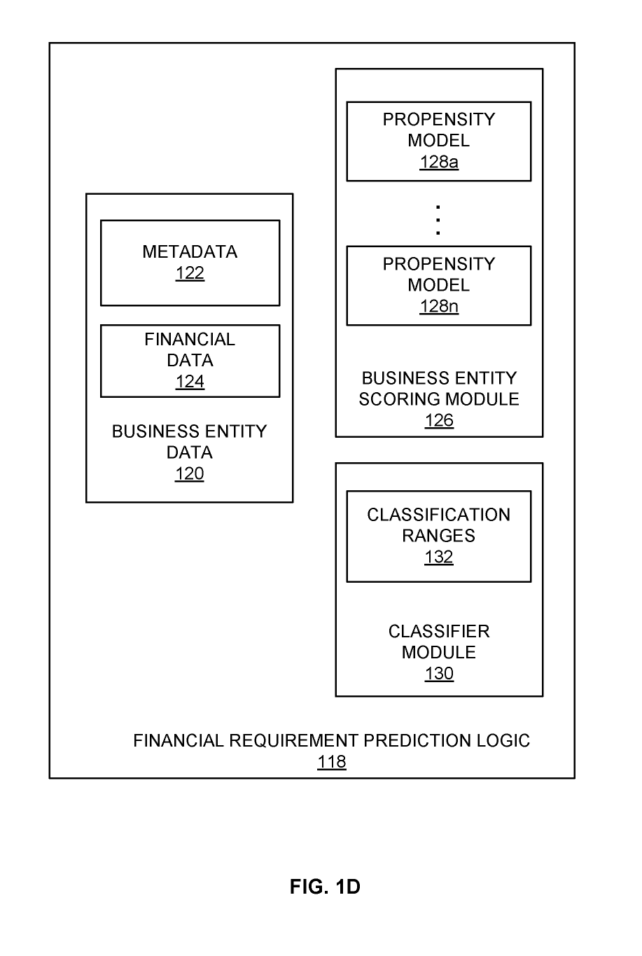

FIG. 1A, depicts a schematic block diagram of a system (100) for identifying a future financial requirement, in accordance with one or more embodiments of the invention. In one or more embodiments of the invention, one or more of the elements shown in FIG. 1A may be omitted, repeated, and/or substituted. Accordingly, embodiments of the invention should not be considered limited to the specific arrangements of modules shown in FIG. 1A.

As illustrated in FIG. 1A, the system 100 includes a production environment (104), a data lake (106), an analytics platform (109), and a modeling system (108). The production environment (104) is in communication with a plurality of users (102). Also, the production environment (104) stores account data (105). Further, the production environment (104) is in communication with the data lake (106), and the data lake (106) is in communication with the analytics platform (109) and the modeling system (108). Also, the analytics platform (109) is shown in communication with the modeling system (108).

In one or more embodiments, the production environment (104), the data lake (106), the analytics platform (109), and the modeling system (108) may be separate physical computing systems that communicate via one or more computer networks. Similarly, the users (102) may communicate with the production environment (104) via one or more computer networks. As non-limiting examples, the computer network(s) may include wired and/or wireless portions of public and/or private data networks, such as wide area networks (WANs), local area networks (LANs), the Internet, etc.

In one or more embodiments, the production environment (104) includes any computing environment that provides for the real-time execution of a platform by users (102) of the platform. The production environment (104) may include processes, data, computational hardware, and software that perform specific tasks. The tasks may be performed by the production environment (104) on behalf of the users, in furtherance of organizational or commercial objectives of the users. For example, the production environment (104) may host a financial management platform that is used by the users. Specifically, the financial management platform may be utilized by the users to operate a business, such as, for example, by performing accounting functions, running payroll, calculating tax liabilities, billing customers, creating invoices, etc. More specific examples of financial management platforms include Intuit QuickBooks, Intuit TurboTax, etc.

As an option, the users of the platform may include individuals or clients that connect to the production environment (104) on behalf of respective businesses (i.e., “business entities”). Accordingly, each of the users (102a-102n) may include an individual operating a desktop computer, portable computer (e.g., laptop, netbook, etc.), or mobile device (e.g., tablet computer, cellular phone, smartphone, etc.), etc., to access the production environment (104) on behalf of a business entity. Each of the users (102a-102n) may utilize a local application (e.g., web browser) for accessing the production environment (104). Moreover, the users or business entities operating on the platform may pay for access to, and use of, the platform, such as, for example, in a subscription model.

In one or more embodiments, the production environment (104) may store account data (105). The account data (105) includes any information stored on the production environment (104) that is associated with, or utilized in the course of, a user's (102) interaction with a platform executing on the production environment (104). For example, where the production environment (104) includes a financial management platform executing thereon, and the financial management platform is utilized by user A (102a) for managing the operation of a business, then the account data (105) may include invoicing information, billing information, inventory information, payroll information, and/or user access metadata, etc. For purposes of simplicity, this data may herein be referred to as “business entity data.”

In one or more embodiments, the data lake (106) includes any large-scale data storage system. The data lake (106) may include structured and/or unstructured data. For example, the data-lake may store tables, objects, files, etc. In one or more embodiments, the data lake (106) includes a copy of the account data (105) of the production environment (104). For example, as the users (102) utilize a platform of the production environment (104), changes to the account data (105) may be duplicated or pushed to copies located in the data lake (106). As described in more detail below, contents of the data lake (106) may be utilized by the modeling system (108) and/or the analytics platform (109) to create a propensity model, apply a propensity model to business entity data, and/or score a business entity based on a propensity model application, without impacting the account data (105) of the production environment (104). For example, the data lake (106) may be utilized for running queries, performing feature engineering, and other data analytics operations. As an option, the data lake (106) may operate on a clustered computing environment, such as a Hadoop cluster.

In one or more embodiments, the analytics platform (109) includes any environment for performing computational and/or statistical analysis. As an option, the analytics platform (109) includes a massively parallel processing system. Accordingly, the analytics platform (109) may be employed to rapidly explore data stored in the data lake (106). For example, the analytics platform (109) may perform feature engineering or feature generation on contents of the data lake (106). As an option, the analytics platform (109) may include a commercial computing system, such as IBM Netezza or Hewlett-Packard Vertica.

In one or more embodiments, the modeling system (108) includes a computing system operable to generate a propensity model. In one or more embodiments, the modeling system (108) may utilize the data lake (106) and/or the analytics platform (109) to generate a propensity model. For example, the analytics platform (109) may, under the control of the modeling system (108), perform feature engineering to identify deterministic aspects of business entity data, and subsequently generate rules based on such features. Moreover, a propensity model may be built using the generated rules. For example, the rules may be included in a rule ensemble-type model.

FIG. 1B shows a financial requirement prediction system (110) in accordance with one or more embodiments of the invention. The prediction system (110) is shown to include a hardware processor (112), memory (114), a data repository (116), financial requirement prediction logic (118), and a message transmission model (117), each of which are discussed in more detail below.

The financial requirement prediction logic (118) includes hardware and/or software for predicting a financial requirement of a business entity. As used herein, the “financial requirement” may include a future financial need of the business entity. As described in more detail below, the financial requirement may be identified using financial data and/or metadata associated with the business entity. Moreover, a “business entity” includes any person or company that is engaged in a commercial enterprise. For example, in one or more embodiments, a business entity may include a physician practicing as a solo practitioner in the state of California. As another example, a business entity may include a bakery with a downtown storefront in Philadelphia, Pa., and which is incorporated in the state of Delaware. As described in more detail below, any interaction of an employee of the business entity with a financial management platform may be attributed to the business entity. For example, the creation of transaction records (e.g., sales records, purchase orders, etc.) by an employee of the bakery in Philadelphia may be attributed, within the financial management platform, to the bakery.

In one or more embodiments, business entity data may be stored in the data repository (116). As described in more detail below, the business entity data may include financial data and/or metadata associated with one or more business entities. In one or more embodiments, the business entity data in the data repository (116) may include the data of business for which a financial need will be determined.

For example, the data repository (116) may include numerous records, where each record is associated with a different business entity. Moreover, each record includes data of the corresponding business entity, where the included data matches the rules of a propensity model. In other words, only a portion of a given business entity's data stored in a production environment may be present in a record in the data repository (116). Also, the data repository (116) may store the data of only a subset of the business entities of a production environment. In this manner, some data (e.g., columns, etc.) associated with a given business entity that is not useful for predicting a financial need of the business entity may be excluded from storage at the data repository (116), and the data of some business entities may be altogether excluded from storage at the data repository (116).

Continuing with FIG. 1B, in one or more embodiments, the data repository (116) is any type of storage unit and/or device (e.g., a file system, database, collection of tables, or any other storage mechanism) for storing data. Further, the data repository (116) may include multiple different storage units and/or devices. The multiple different storage units and/or devices may or may not be of the same type or located at the same physical site.

In one or more embodiments, the hardware processor (112) includes functionality to execute the financial requirement prediction logic (118).

Moreover, the financial requirement prediction logic (118), or a copy thereof, may reside in the memory (114) during the execution. In one or more embodiments, financial requirement prediction system (110) may include hardware components (not shown) for enabling communication between the hardware processor (112), the memory (114), the data repository (116), the financial requirement prediction logic (118), and/or the message transmission module (117). For example, the prediction system (110) may include a system bus for communication between the hardware processor (112), the memory (114), the data repository (116), the financial requirement prediction logic (118), and/or the message transmission module (117).

Further, as described herein, the message transmission module (117) includes logic for providing a message to a business entity. In one or more embodiments, the message transmission module (117) may include software and/or hardware for initiating transmission, via a computer network, of an electronic message to a business entity. In such embodiments, the message may include an email, a web page, or an advertisement. In one or more embodiments, the message transmission module (117) may include software and/or hardware for initiating transmission, via physical correspondence, of a message to a business entity. In such embodiments, the message may include printed matter (e.g., a letter, postcard, flyer, etc.) or other promotional material that delivered to a mailing address of a business entity. As an option, the message transmission module (117) may generate a list of business entities and/or messages. The list of business entities and/or messages may be used (e.g., by a third-party vendor) for sending the messages via physical correspondence to the business entities in the list.

Continuing with FIG. 1B, in one or more embodiments, the message transmission module (117) may be pre-configured with policies. Moreover, based on the policies, the message transmission module (117) may determine whether a given business entity will receive an electronic message or physical correspondence. For example, the financial requirement prediction logic (118) may utilize a score of a business entity to classify a future financial requirement of the business entity, and the message transmission module (117) may then transmit a message to the business entity based on the classification of the future financial requirement.

Referring now to FIG. 1C, the financial requirement prediction logic (118) includes business entity data (120), a business entity scoring module (126), and a classifier module (130). Further, the business entity data (120) is shown to include financial data (124) and metadata (122). Also, the business entity scoring module (126) is shown to include a propensity model (128). The classifier module (130) is shown to include classification ranges (132). Each component of the financial requirement prediction logic (118) is discussed in more detail, below.

In one or more embodiments, the business entity data (120) includes the data of a business entity. More specifically, the business entity data (120) includes financial data (124) and metadata (122) of a given business entity.

In one or more embodiments, the financial data (124) of a business entity includes any economic data associated with, generated by, or generated on behalf of, the business entity during the course of its commercial operations. As an option, the financial data (124) may include cash flow or transaction information. Transaction information of a business entity may include one or more of invoice information of the business entity, deposit information of the business entity, and expense information.

More specific examples of transaction information include a number of invoices issued by the business entity for a time period, a total value of the invoices for a time period, and/or an average value of the invoices for a time period, etc. Also, as an option, the transaction information may include a value of outstanding invoices due to be paid to the business entity, a number of outstanding invoices due to the business entity, and a spread of the outstanding invoices among customers of the business entity. Further, the transaction information may include a value of payments received by the business entity, a number of bank deposits performed by the business entity, a total value of deposits for a time period, and/or an average value of deposits for a time period, etc. Still yet, the transaction information may include the value of outstanding bills the business entity is due to pay, a number of expenses of the business entity for a time period, a total value of the expenses for a time period, a relative amount of expenses to invoices, and/or an average value of the expenses for a time period, etc.

Also, the financial data (124) of a business entity may include, for example: a net worth of the business entity; a tangible net worth of the business entity; a net margin of the business entity; an annual sales revenue of the business entity; a monthly average of the credits of the business entity; a number of days turnover of accounts receivable for the business entity; sales growth of the business entity; earnings of the business entity before interest, taxes, depreciation, and amortization; and transaction information of the business entity.

As an option, the financial data (124) may include week-over-week, month-over-month, year-over-year, etc. trends of any of the above information, expressed as a dollar value or a percentage.

Continuing with FIG. 1C, in one or more embodiments, the metadata (122) includes any non-economic information maintained about a given business entity. The metadata (122) of a business entity may be recorded by a platform as users associated with the business entity interact with the platform. For example, the metadata (122) of a given business entity may be collected as users associated with the business entity input new items in an inventory tracked utilizing the financial management platform. Accordingly, the metadata (122) for a given business entity may also be herein referred to as platform metadata. In one or more embodiments, the metadata (122) may include audit history data or clickstream data. For example, the metadata (122) may include transaction record creation activities, transaction record closing activities, platform logins, reporting activities by, and/or viewing activities of one or more users of the business entity.

Other specific illustrations of the metadata (122) include, for example: a number of inventory items recorded in a financial management platform; a version of a financial management platform utilized by a business entity (e.g., an older version of the platform instead of upgrading to a newer version); the roles (e.g., cashiers, managers, accountants, etc.) of users with access to a financial management platform utilized by a business entity; the last time a user of the business entity accessed the financial management platform for managing the commercial activities of the business entity; a number of accesses of the financial management platform by users of the business entity; a duration of time that the business entity has utilized the financial management platform; a geographic location of operation of the business entity; a business classification of the business entity; and an age of the business entity.

In one or more embodiments, the duration of time that the business entity has utilized the financial management platform may be calculated utilizing a first charge date. A first charge date includes a past point in time that is identified as the beginning of a business relationship between the business entity and the financial management platform (i.e., the beginning date of a subscription to the financial management platform, etc.). As an option, the first charge date may be represented as calendar date (e.g., Jan. 3, 2013, May 10, 2011, etc.); or as a measurable quantity of time periods between the first charge date and a given date (e.g., 8 weeks, 56 days, 2 months, 0.154 years, etc.). The given date may be a current date, a date that has already passed, or a date in the future.

As an option, the age of the business entity may be determined based on input from a user of the business entity. For example, the user may specify that the business was started in 1990, or has been doing business for 26 years. As another option, the age of the business entity may be determined from a third-party source. For example, a year of incorporation of the business entity, or other starting date, may be obtained from public records (e.g., Secretary of State, Division of Corporations, etc.), or from a private entity, such as Dun & Bradstreet.

A rule directed to a geographic location of operation of the business entity may include a condition regarding a country of operation (e.g., United States of America, Canada, etc.), a region of operation (e.g., Pacific Northwest, etc.), a state of operation (e.g., California, Illinois, Arkansas, etc.), a city of operation of the business entity. Also, a rule directed to a business classification of the business entity may rely on a standardized classification system, such as, for example, North American Industry Classification System (NAICS).

Additional illustrations of the metadata (122) include, for example: demographics of the customers of the business entity; employee information, such as the number of employees of the business entity; observed bookkeeping practices of the business entity; a general climate of the business entity's commercial practices; an overall climate of a localized, regional, national, or global economy; economic trends; the tax form(s) utilized by the business entity to report income to a government; opinions and reviews of the business entity as determined from social networks; and a number of packages being regularly shipped (e.g., per day, week, month, etc.) by the business entity.

Continuing with FIG. 1C, bookkeeping practices may include when users of the business entity update transaction records (e.g., time of a day), a frequency with which the users of the business entity update transaction records, and/or locations from which the users of the business entity update transaction records in accordance with one or more embodiments of the invention. For example, all other things being equal, a business entity that has an accountant maintaining the books of the business entity on a regular weekly basis may be scored lower by the propensity model than a business entity that has a user updating transactions once every month.

The financial data (124) and the metadata (122) of a given business entity may be utilized as input to the propensity model (128) of FIG. 1C for determining a financial need of the business entity, as described in more detail below.

In one or more embodiments, the propensity model (128) of FIG. 1C may be generated by the modeling system (108) shown in FIG. 1A using the analytics platform (109) and/or the data lake (106). Accordingly, the modeling system (108) may generate the propensity model (128) using the account data (105), or a subset thereof, that originates from the production environment (104).

In one or more embodiments, the business entity scoring module (126) applies the propensity model (128) of FIG. 1C to the business entity data (120) to generate a score for a business entity. In one or more embodiments, the propensity model (128) may include a plurality of different rules. Accordingly, applying the propensity model (128) to the business entity data (120) may include testing or comparing the business entity data (120) against the rules of the propensity model (128).

For example, by applying the propensity model (128) of FIG. 1C to the data (120) of a business entity, one or more aspects of the financial data (124) and/or the metadata (122) may be compared to rules regarding financial data.

Additionally, for any of the various types of the metadata (122), changes over a period of time may be observed and utilized within the propensity model (128) for scoring the business entity. For example, due to rules of the propensity model (128), a business entity that has been shipping an increasing number of packages month-over-month may score more highly than a business that has been consistently shipping the same number of packages month-over-month.

As an option, a rule in the propensity model (128) may combine one or more financial aspects of the financial data (124) with one or more aspects of the non-financial metadata (122). For example, a given rule may include a condition regarding a first charge date of the business entity, as well as a condition regarding sales growth of the business entity.

Continuing with FIG. 1C, in one or more embodiments, each of the rules in a propensity model (128) may be associated with a support value, a coefficient, and/or an importance value. The support value of a rule may indicate a fraction of time for which the condition of the rule was true, based on the data that was used to build the propensity model (128) that includes the rule. For example, if a propensity model (128) includes a rule with the conditions of “STATE==CA & OUTSTANDING_INVOICES>=17,” and a support value of 0.643, the support value would indicate that of the business entities whose data was used to build the propensity model (128), approximately 64.3% of those business entities were located in California and had at least 17 outstanding invoices. Additionally, the coefficient of a rule may indicate an impact the rule has on the outcome, where an absolute value of the coefficient indicates a weight (i.e., less likely to need financing). Accordingly, a larger coefficient may result in a greater impact on a final score that is output from the propensity model (128) that the rule is included in. As an option, each coefficient may be either positive or negative. Thus, the sign of a given coefficient may indicate whether the coefficient impacts a final score in an increasing or decreasing manner (i.e., increases or decreases the final score when the associated rule is determined to be true).

In one or more embodiments, the importance value of a rule may be a global measure reflecting an average influence of a predictor over the distribution of all joint input variable values for the propensity model (128) that the rule is included in. In one or more embodiments, the rules of a given propensity model (128) may be ranked within the propensity model (128) based on the corresponding importance values of each of the rules within the propensity model (128).

In one or more embodiments, a propensity model (128) may be expressed as a mathematical formula, such that the application of the propensity model (128) to the business entity data (120) includes calculating a score for the business entity according to the mathematical formula. For example, application of the propensity model (128) to the business entity data (120) may include determining, for each rule in the propensity model (128), whether or not the rule is true when applied to the data (120) of the business entity. If the rule is true, then a pre-determined value may be multiplied by the coefficient associated with the rule to generate a result. This may be repeated for each of the rules in the propensity model (128) utilizing the business entity data (120) to generate a plurality of results. Moreover, each of the results may be summed to calculate a score of the business entity. As an option, the summation of the results may be adjusted or normalized to calculate the score of the business entity.

For example, if a given propensity model (128) includes two rules, then business entity data (120) may be gathered such that the business entity data (120) matches the two rules. Further, the business entity scoring module (126) may score the business entity by, for each rule in the propensity model (128), determining whether the rule, as applied to the data (120) of the business entity, evaluates as true or false. For each of the rules that evaluates as true, a coefficient associated with that rule is multiplied by a value of ‘1,’ and for each of the rules that evaluates as false, the coefficient associated with that rule is multiplied by a value of ‘0.’ Moreover, the products may be summed. Thus, if a first rule in the propensity model (128) is associated with a coefficient of 0.880, and a second rule in the propensity model (128) is associated with a coefficient of −0.349, then a score of 0.531 may be calculated for the business entity when both rules evaluate as true (i.e., (1*0.880)+(1*−0.349)=0.531).

In one or more embodiments, a given propensity model (128) may be utilized to score numerous business entities. For example, the business entities may be scored in parallel, as a batch, etc.

Continuing with FIG. 1C, in one or more embodiments, the classifier module (130) includes hardware and/or software for segmenting business entities based on the scores attributed to the business entities by the business entity scoring module (126). In one or more embodiments, the classifier module (130) may classify the business entities using the classification ranges (132). As an option, the classification ranges (132) may include one or more pre-determined ranges of values, where each of the ranges is associated with a discretized level of financial need.

For example, business entities may be classified by dividing up the business entities into four quartiles. Those business entities classified in the highest 25% of scores may have the greatest likelihood of needing a financial infusion or loan product, which may be used to help the business grow. Conversely, those business entities classified in the lowest 25% of scores may be identified as having the lowest likelihood of needing a financial infusion or loan product. As an option, by classifying the business entities, those with the greatest future financial requirement may be rapidly identified and offered a loan product.

Turning to FIG. 1D, the business entity scoring module (126) may include two or more different propensity models (e.g., 128a, 128n) in accordance with one or more embodiments of the invention. For example, the financial requirement prediction logic (118) includes a business entity scoring module (126) with at least two propensity models (e.g., 128a, 128n), in accordance with one or more embodiments of the invention.

Thus, in one or more embodiments, the business entity scoring module (126) may apply two or more propensity models (e.g., 128a, 128n) to the business entity data (120) to generate two or more scores for the business entity. For example, the business entity scoring module (126) may apply a first propensity model (128a) to the business entity data (120) to generate a first score for the business entity, and apply a second propensity model (128n) to the business entity data (120) to generate a second score for the business entity. In one or more embodiments, each of propensity models (e.g., 128a, 128n) may include a plurality of different rules, and the rules may be different between the different propensity models (e.g., 128a, 128n). Accordingly, applying the first propensity model (128a) to the business entity data (120) may include testing or comparing the business entity data (120) against a first plurality of rules of the first propensity model (128a) to generate the first score, and testing or comparing the business entity data (120) against a second plurality of rules of the second propensity model (128n) to generate the second score.

For example, the financial data (124) and the metadata (122) of the business entity may be utilized as input to a first propensity model (128a) to determine a first future financial requirement of the business entity, and as input to a second propensity model (128n) to determine a second future financial requirement of the business entity. In one or more embodiments, the different financial requirements may be associated with different types of financing. For example, the first financial requirement may be associated with a first type of financing, and the second financial requirement may be associated with a second type of financing that is different than the first type of financing. As an option, the types of financing may include equipment financing, invoice financing, credit card or credit line financing, term loan financing, and/or business loan financing. As used herein, invoice financing may include a loan provided to a business entity based on amounts due from the customers of the business entity. Also, equipment financing may include a loan used to purchase business equipment.

Accordingly, for example, the first propensity model (128a) may be utilized to determine a future requirement of the business entity with respect to equipment financing, while the second propensity model (128n) may be utilized to determine a future requirement of the business entity with respect to invoice financing or another type of financing. As a result, a business that operates in an industry that typically has a significant number of outstanding invoices, but does not invest heavily in equipment, may have little use for an equipment financing offer, but a significant need for an invoice financing offer at some point in the future.

Continuing with FIG. 1D, a given rule may be included in two or more of the different propensity models (e.g., 128a, 128n) in accordance with one or more embodiments of the invention. Also, the rule may be associated with different support values, coefficients, and/or an importance values between the different propensity models (e.g., 128a, 128n). For example, a particular rule may be associated with a significantly greater coefficient, importance value, and/or support value within a first propensity model (128a) than within a second propensity model (128n).

In one or more embodiments, the business entity data (120) may be gathered to match the rules of the propensity models (e.g., 128a, 128n). For example, if a first propensity model (128a) includes two rules, and a second propensity model (128n) includes a different three rules, then business entity data (120) may be gathered such that the business entity data (120) matches the two rules of the first propensity model (128a) and the three rules of the second propensity model (128n). Further, the business entity scoring module (126) may score the business entity utilizing each of the two propensity models (e.g., 128a, 128n).

In one or more embodiments, the propensity models (e.g., 128a, 128n) may be utilized to score numerous business entities. For example, the business entities may be scored in parallel, as a batch, etc.

In one or more embodiments, a first score from a first propensity model (128a) and a second score from a second propensity model (128n) may be compared. Moreover, based on the comparison, a representative score for the business entity may be selected, as described in more detail below.

For purposes of simplicity and clarity, the business entity scoring module (126) of FIG. 1D is illustrated to include a first propensity model (128a) and a second propensity model (128n), however it is understood that the business entity scoring module (126) may store more than two different propensity models (e.g., 128a, 128n). Accordingly, more than two different scores may be generated for a given business entity, and a representative score may be selected from three, four, five, dozens, hundreds, etc. different scores.

As an option, the classification ranges (132) may include a set of ranges for each of the propensity models (e.g., 128a, 128n). For example, the classification ranges (132) may include a first set of ranges for a first propensity model (128a), a second set of ranges for a second propensity model (128n), etc. Each set of ranges may be used to classify a score output from the corresponding propensity model (e.g., 128a, 128n). For example, the first set of ranges may be used to classify a score of the first propensity model (128a), and the second set of ranges may be used to classify a score of the second propensity model (128n), etc.

Moreover, each of the sets of ranges may include one or more pre-determined ranges of values, where each of the ranges is associated with a discretized level of financial need. As an option, one or more of the sets of ranges may be divided up into four pre-determined ranges of values, or four quartiles. For example, a first set of ranges used to classify a score of a first propensity model (128a) may include four pre-determined ranges of values, where each range is associated with a corresponding quartile of future financial need (e.g., significant, moderate, low, none, etc.).

Accordingly, as shown in FIG. 1D, where the classification ranges (132) include different sets of ranges for the different propensity models (e.g., 128a, 128n), the sets of ranges may be used to classify and differentiate the different scores for a given business entity. For example, a first score from a first propensity model (128a) for invoice financing may fall within a first set of ranges such that it indicates that the business entity has a significant future need for invoice financing; but a second score from a second propensity model (128n) for equipment financing may fall within a second set of ranges such that it indicates that the business entity has no future need for equipment financing.

In one or more embodiments, business entities classified in the highest 25% of scores output by a propensity model (e.g., 128a, 128n) may have the greatest likelihood of requiring the particular type of financial infusion or loan product associated with the propensity model (e.g., 128a, 128n) used to generate the scores. Conversely, those business entities classified in the lowest 25% of scores output by the propensity model (e.g., 128a, 128n) may have the lowest likelihood of requiring the particular type of financial infusion or loan product associated with the propensity model (e.g., 128a, 128n) used to generate the scores.

While FIGS. 1A, 1B, 1C, and 1D show some possible component configurations, other configurations may be used without departing from the scope of the invention. For example, various components may be combined to create a single component. As another example, the functionality performed by a single component may be performed by two or more components.

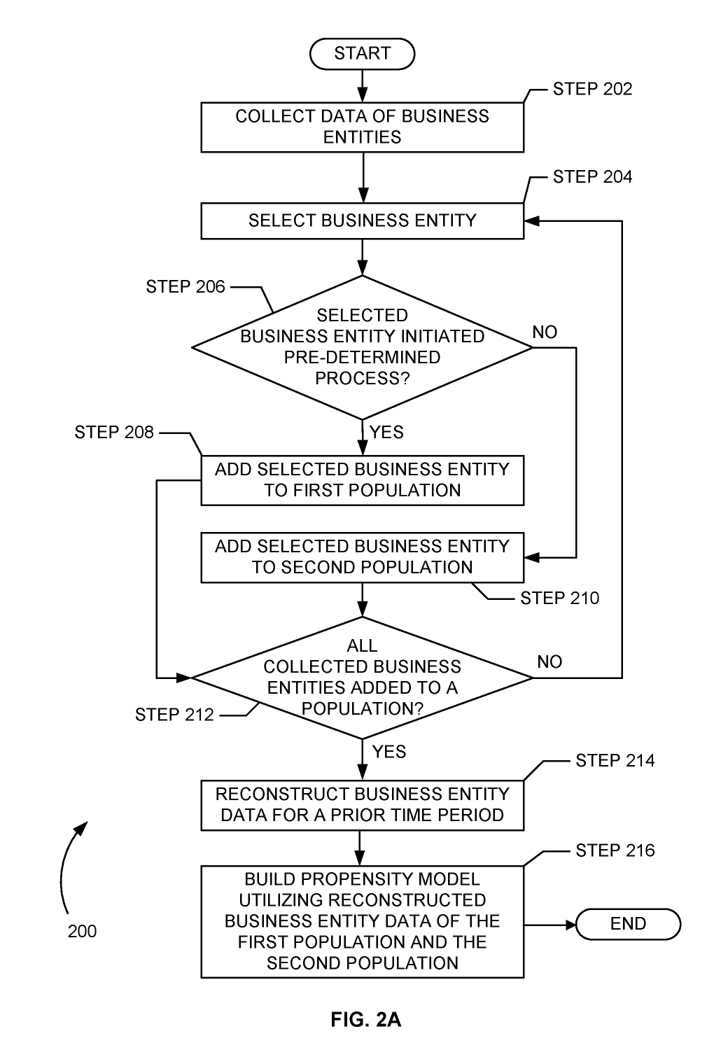

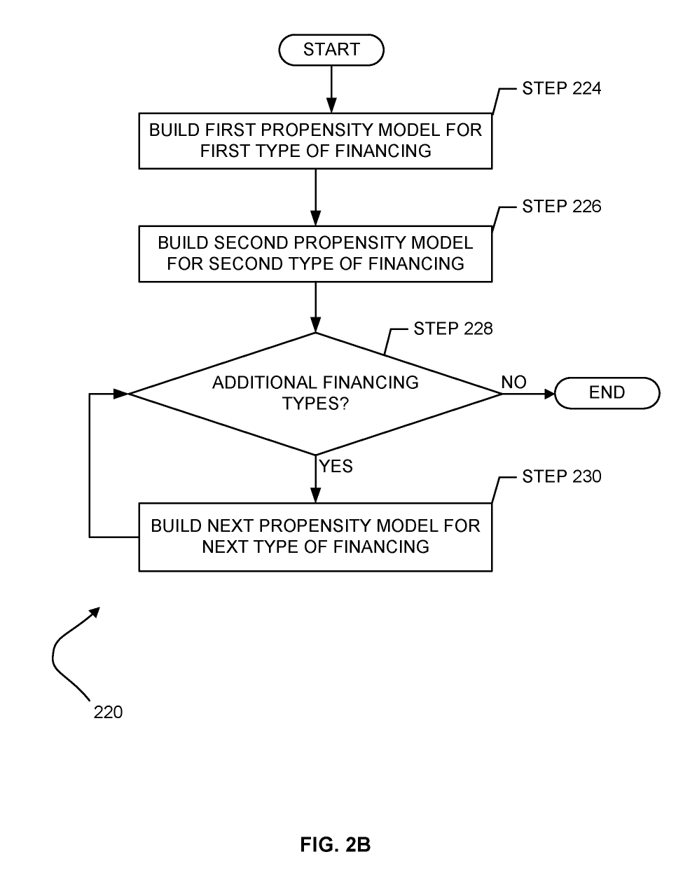

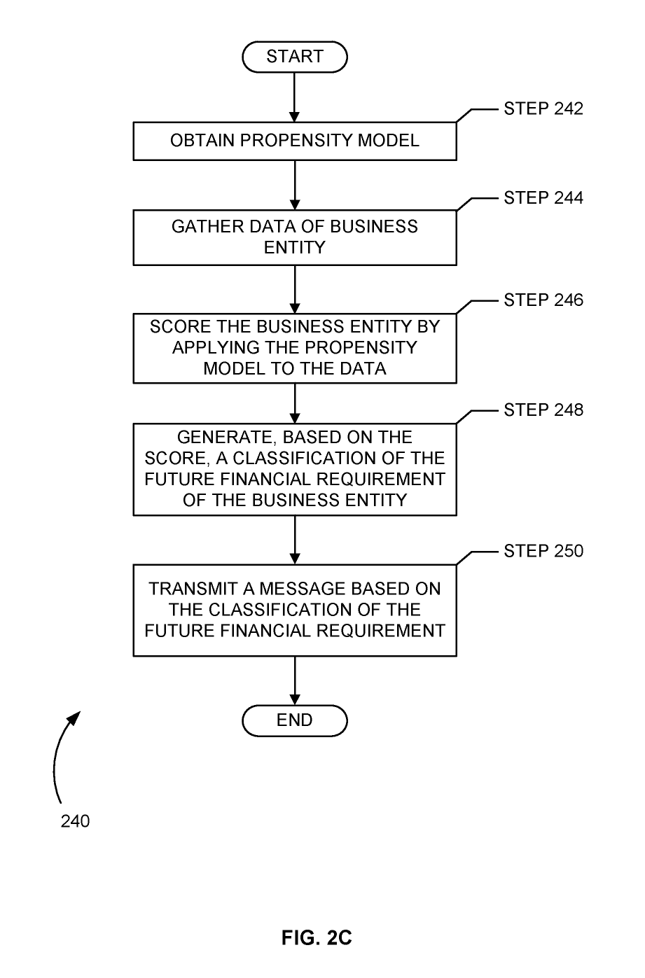

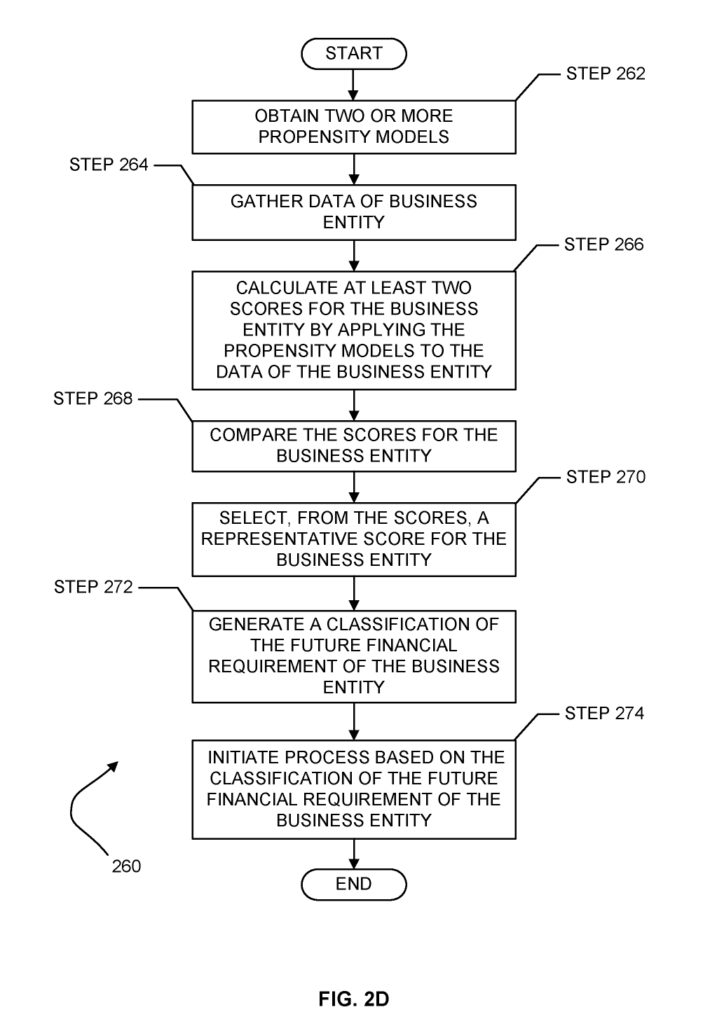

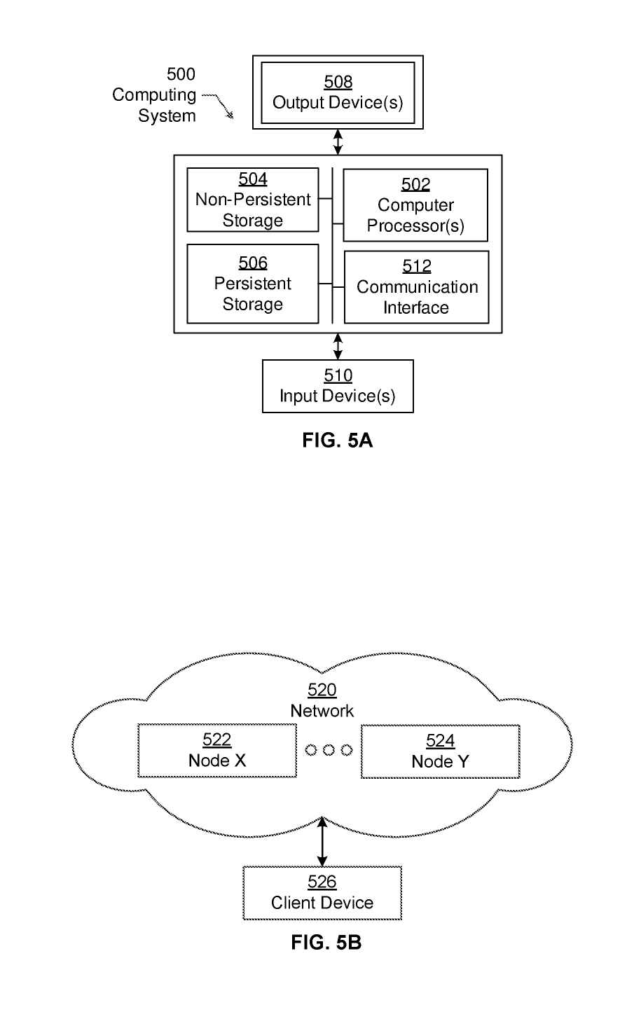

FIG. 2A depicts a flowchart of a method (200) of generating a propensity model to determine a future financial requirement, in accordance with one or more embodiments of the invention. In one or more embodiments, one or more of the steps shown in FIG. 2A may be omitted, repeated, and/or performed in a different order. Accordingly, embodiments of the invention should not be considered limited to the specific arrangements of steps shown in FIG. 2A. In one or more embodiments, the method (200) described in reference to FIG. 2A may be practiced using the system (100) described in reference to FIG. 1A and the system (110) described in reference to FIGS. 1B 1C, and 1D, above, and/or involving the computing system (500) described in reference to FIG. 5A.

At Step 202, data of numerous business entities is collected. In one or more embodiments, the data of the business entities includes financial data of the business entities. For example, the data may include outstanding amounts due, payroll information, and an invoice spread. In one or more embodiments, the data of the business entities includes metadata of the business entities. For example, the metadata may include login and access habits of the users of the business entities. Moreover, collecting the data may include any acquisition of the data. For example, the data may be retrieved from a production environment (104) or data lake (106), as described in the context of FIG. 1A.

In one or more embodiments, each of the business entities for which data is collected at Step 202 may have previously received an actionable offer for financing. In one or more embodiments, each of the business entities for which data is collected at Step 202 may have previously received a particular type of actionable offer. The previously received actionable offer may include an offer for a particular type of financing, such as, for example, equipment financing, invoice financing, a credit card or credit line, a term loan, a business loan, etc. In other words, each of the business entities for which data is collected at Step 202 may have previously received an offer for the same particular type of financing.

As an option, the actionable offers may have been provided to the business entities by physical correspondence (e.g., a mailed letter, postcard, etc.), by electronic correspondence (e.g., email, instant message, etc.), and/or as a targeted advertisement (e.g., advertisement in a webpage, etc.).

A first one of the business entities is selected at Step 204. Next, at Step 206, it is determined whether the selected business entity initiated a pre-determined process. In one or more embodiments, the pre-determined process may include any action taken in response an actionable offer. For example, the pre-determined process may include activating a link in response to the actionable offer, filling out a form in response to the actionable offer, calling a phone number in response to the actionable offer, submitting a loan application in response to the actionable offer, calling a loan officer in response to the actionable offer, and/or visiting a website in response to the actionable offer. In other words, where the actionable offer includes an offer for equipment financing, then the pre-determined process may include an event that indicates the business entity showed interest in the equipment financing.

If, at Step 206, it is determined that the selected business entity initiated the pre-determined process, then the selected business entity is added, at Step 208, to a first population of business entities. However, if, at Step 206, it is determined that the selected business entity did not initiate the pre-determined process, then the selected business entity is added, at Step 210, to a second population of business entities. In one or more embodiments, the selected business entity may be added to a population by setting a flag associated with the business entity. For example, a first flag (i.e., a bit ‘1’, etc.) may be associated with the selected business entity if it initiated the pre-determined process, and a second flag (i.e., a bit ‘0’, etc.) may be associated with the selected business entity if it did not initiate the pre-determined process.

Moreover, at Step 212, it is determined whether all business entities for which data has been collected have been added to the first population or the second population. If there are unclassified business entities remaining, such that at least one business entity has not been placed into the first population or the second population, then the method (200) returns to Step 204, where a next business entity is selected. Further, the next business entity is classified as belonging to the first population or the second population according to Steps 206-210, as described above. In one or more embodiments, the classification of the business entities into the first and second populations may occur in a parallel manner, such that multiple business entities are simultaneously added to the two populations.

Accordingly, the classification of the business entities, for which data was collected at Step 202, continues until all of the business entities have been added to either the first population or the second population. Moreover, when it is determined, at Step 212, that all of the business entities have been added to one of the two populations, then the instances of business entity data are reconstructed, at Step 214. Moreover, the reconstruction of the business entity data is performed such that the reconstructed business entity data is representative of a prior time period.

For example, in one or more embodiments, the data for each of the business entities may include a corresponding transaction log, referred to herein as an audit history. For a given business entity, the audit history of the business entity may include a record (e.g., a line, a row, etc.) that indicates an action taken on behalf of the business entity, as well as a timestamp. The timestamp may include a date and/or time the action was performed. Moreover, the action taken on behalf of the business entity may include any action performed by the business entity, or a user associated with the business entity, within a production environment, such as the production environment (104) of FIG. 1A. For example, the business entity may include various user accounts (e.g., an accountant, a manager, a cashier, etc.) that are associated with the business entity. The various users may access a financial management platform hosted within a production environment. Within the financial management platform, the users may generate transaction data by creating invoices, making sales, applying payments to accounts, or performing other business transactions. A record of each transaction may be kept in an audit history of the business entity.

Accordingly, during a reconstruction of the data of the business entity, one or more transactions may be removed to generate reconstructed data for the business entity. In one or more embodiments, the removed transactions may include all transactions that occurred after a specified date. In other words, the reconstructed data of a business entity may include only transactions that were performed on behalf of the business entity on or prior to a particular date. As an option, the particular date may be a pre-determined time period prior to receipt, by the business entity, of an actionable offer. In other words, the particular date used to generate reconstructed data for a business entity may be a number of days, weeks, months, or years prior to when the business entity received an actionable offer.

For example, for a given business entity that receives an actionable offer for invoice financing, all transactions that occurred subsequent to three months before the day the invoice financing offer was received may be removed from the data of the business entity to generate the reconstructed business entity data. In this way a snapshot of the business entity may be created that represents a state of the business entity before it was offered the invoice financing. Moreover, at Step 214, such snapshots may be created for all business entities in the first population and the second population. In this way, different business entities may receive offers for a particular type of financing, such as, for example, invoice financing, on different dates, and the business entity snapshots consistently represent the respective states of the different business entities at corresponding earlier dates.

Next, at Step 216, a propensity model is built utilizing the reconstructed business entity data of the business entities in the first population and the second population. In one or more embodiments, the propensity model is built using machine learning, such as, for example, by applying a rule ensemble method to the reconstructed data of the business entities. For example, building the propensity model may include generating different rules, testing the rules against the reconstructed business entity data, and then ranking the different rules. Each of the rules may include one or more conditions. As an option, the ranks assigned to the rules may be determined by logistic regression. Also, a given propensity model may be configured to include tens, hundreds, or thousands of rules.

In one or more embodiments, after building the propensity model, the rules of the propensity model may be modified. As an option, the rules may be modified manually, by a data scientist or engineer. A rule may be modified by altering its coefficient, by deleting a rule, by changing conditional values, etc. For example, using the example described above, where the rule includes a condition of “OUTSTANDING_INVOICES>=17,” the condition of the rule may be modified to require “OUTSTANDING_INVOICES>=19.” In this way, the strength of the propensity model may be iteratively tested and improved.

Because the propensity model is built utilizing the reconstructed data of the two populations, the propensity model may serve to identify differences that differentiate the data of the business entities that initiated a pre-determined process from those that did not initiate the pre-determined process. Moreover, where the propensity model is built for a particular type of actionable offer, the propensity model may serve to identify differences that differentiate the data of business entities that initiated a pre-determined process for a particular type of actionable offer, from the business entities that did not initiate the pre-determined process for the particular type of actionable offer.

After the propensity model has been built, it may be tested using testing data. In particular, the testing data may include data for numerous business entities that previously received the particular type of actionable offer. Moreover, for each of the business entities included in the testing data, the outcome of whether the business entity initiated the pre-determined process, in response to the particular type of actionable offer, may be known. For example, the testing data may include a plurality of business entities that received offers for invoice financing, and, for each of the business entities in the testing data, it is known whether or not that business entity initiated the process of applying for invoice financing in response to the offer.

FIG. 2B depicts a flowchart of a method (220) of building different propensity models for different types of financing, in accordance with one or more embodiments of the invention. In one or more embodiments, one or more of the steps shown in FIG. 2B may be omitted, repeated, and/or performed in a different order. Accordingly, embodiments of the invention should not be considered limited to the specific arrangements of steps shown in FIG. 2B. In one or more embodiments, the method (220) described in reference to FIG. 2B may be practiced using the system (100) described in reference to FIG. 1A and the system (110) described in reference to FIGS. 1B, 1C, and 1D, above, and/or involving the computing system (500) described in reference to FIG. 5A.

At Step 224, a first propensity model is built for a first type of financing. In one or more embodiments, the first propensity model is built according to the Steps 202-216 of the method (200) of FIG. 2A. For example, the first propensity model may be built, at Step 224, using the data of numerous business entities that each received an offer for the first type of financing. Each of the business entities that received an offer for the first type of financing may be divided into a first population or second population based on their respective responses to an offer for the first type of financing, and the data of each of the entities may be reconstructed.

Similarly, at Step 226, a second propensity model is built for a second type of financing. In one or more embodiments, the second propensity model is built according to the Steps 202-216 of the method (200) of FIG. 2A. For example, the second propensity model may be built, at Step 226, using the data of numerous business entities that each received an offer for the second type of financing. Each of the business entities that received an offer for the second type of financing may be divided into a first population or second population based on their respective responses to an offer for the second type of financing, and the data of each of the entities may be reconstructed.

Moreover, the second type of financing is different than the first type of financing. For example, the first type of financing may be equipment financing, and the second type of financing may be invoice financing. As another example, the first type of financing may be equipment financing, and the second type of financing may be a term loan. As yet another example, the first type of financing may be a business loan, and the second type of financing may be equipment financing. In this way, each propensity model of at least two propensity models is associated with a different future financial requirement.

Additionally, at Step 228, it is determined whether a propensity model should be built for an additional type of financing. In one or more embodiments, the additional type of financing may have been offered to the business entities. Accordingly, if it is determined, at Step 228, that no additional types of financing have been offered to the business entities, then the method (220) ends. However, if it is determined, at Step 228, that another propensity model should be built for another type of financing, then the other propensity model is built, at Step 230, for the other type of financing. The other type of financing, for which the propensity model is built at Step 230, may be different than both the first type of financing and the second type of financing. The other propensity model may be built, at Step 230, according to the Steps 202-216 of the method (200) of FIG. 2A.

Moreover, after building the next propensity model at Step 230, the method (220) returns to Step 228 to determine whether a propensity model should be built for any further types of financing. In this manner, the method (220) may allow for the building of a different propensity model for each type of financing offer that has been sent to a population of business entities.

FIG. 2C depicts a flowchart of a method (240) of utilizing a propensity model to determine a future financial requirement, in accordance with one or more embodiments of the invention. In one or more embodiments, one or more of the steps shown in FIG. 2C may be omitted, repeated, and/or performed in a different order. Accordingly, embodiments of the invention should not be considered limited to the specific arrangements of steps shown in FIG. 2C. In one or more embodiments, the method (240) described in reference to FIG. 2C may be practiced using the system (100) described in reference to FIG. 1A and the system (110) described in reference to FIGS. 1B and 1C, above, and/or involving the computing system (500) described in reference to FIG. 5A

A propensity model is obtained at Step 242. Moreover, the propensity model models how data of a business entity relates to a future financial requirement of the business entity. For example, the propensity model may utilize a snapshot of a business entity at a current or prior time to determine that the business entity is likely to require a loan at some future point in time (e.g., in 3 months, 6 months, etc.). In one or more embodiments, the propensity model may include a propensity model that has been generated according to the method (200) of FIG. 2A, described above. Of course, the propensity model obtained at Step 242 may be generated by any other relevant method.

Next, at Step 244, data of a business entity is gathered. As described herein, the data of the business entity has been created based on a platform utilized by the business entity. In one or more embodiments, the platform may include a financial management platform that the business entity utilizes in furtherance of one or more business objectives. For example, the financial management platform may be utilized for invoicing, billing, payroll, accounts receivable, and/or tracking stock, etc. The data of the business entity may include financial data and/or metadata. In one or more embodiments, the data of the business entity matches at least a subset of the propensity model. For example, if the propensity model includes a plurality of rules, where one of the rules is based on a geographic location, and another of the rules is based on a number of items in the inventory of the business entity, then the data gathered at Step 244 will include both the geographic location of the business entity and the number of items held in the inventory of the business entity.

As used herein, gathering the data of the business entity includes any process that retrieves or receives the data of the business data. For example, the data of the business entity may be retrieved over a computer network, such as the Internet. In one or more embodiments, the data of the business entity may be gathered from a data lake, such as the data lake (106) described in the context of the system (100) of FIG. 1A, or directly from a repository of user data, such as the account data (105) of the production environment (104) described in the context of the system (100) of FIG. 1A. Of course, however, the data of the business entity may be gathered from any relevant source.

Next, at Step 246, the business entity is scored by applying the propensity model to the data of the business entity. In one or more embodiments, the propensity model includes numerous rules. Moreover, the rules of the propensity model may be based on financial aspects of business entities and/or non-financial aspects of the business entities. As an option, the propensity model may be expressed as a mathematical formula, such that the application of the propensity model to the data of a business entity includes calculating a plurality of values and summing the values. For example, each rule of the propensity model may be associated with a coefficient, each of the coefficients may be multiplied by a ‘0’ or a ‘1’ based on the data of the business entity, and the products may be summed. Also, the sum may be normalized or adjusted. For example, the sum may be adjusted so that it is between 0 and 1, or another pre-determined range.

Also, a classification of a future financial requirement of the business entity is generated, at Step 248, based on the score of the business entity. In one or more embodiments, for each of the business entities scored by applying the propensity model to the data of the business entity, the business entity is classified based on its score.

For example, the business entities may be classified by dividing up the business entities into four quartiles. Those business entities classified in the highest 25% of scores may have the greatest likelihood of needing a loan. Conversely, those business entities classified in the lowest 25% of scores may be identified as having the least likelihood of needing a loan.

In one or more embodiments, at Step 250, a message is transmitted to the business entity. As described hereinabove, the message may include an email, a web page, or an advertisement. Accordingly, the transmission of the message includes any process of sending the message to the business entity in a targeted manner. As previously noted, the transmission may occur via a computer network and/or via physical correspondence.

In one or more embodiments, a content of the message is based on the classification of the future financial requirement of the business entity. In other words, if the business entities are classified into quartiles based on their scores, then all business entities in the top quartile may be transmitted messages for the same, or a similar, offer. For example, all business entities classified in the top quartile may be offered business loans with interest rates between 3-7%. Similarly, all business entities classified in the second quartile may be offered business loans with interest rates between 5-9%.

Further, in one or more embodiments, the method of transmission is based on the classification of the future financial requirement of the business entity. For example, the messages transmitted to all business entities classified in the top quartile may be electronic messages (e.g., web page advertisements, emails, etc.), while the messages transmitted to all business entities classified in any of the other three quarters may be physical correspondence (e.g., postcards, direct mailings, etc.).

In this way, the business entities that are transmitted a message may be prioritized based on classification. This may ensure that those business entities determined to have the greatest financial need are contacted such that they can obtain the necessary financing in an efficient and timely manner, without risk of being forced into a high interest rate loan, or stunting the growth of their business.

FIG. 2D depicts a flowchart of a method (260) of applying multiple propensity models to identify a future financial requirement, in accordance with one or more embodiments of the invention. In one or more embodiments, one or more of the steps shown in FIG. 2D may be omitted, repeated, and/or performed in a different order. Accordingly, embodiments of the invention should not be considered limited to the specific arrangements of steps shown in FIG. 2D. In one or more embodiments, the method (260) described in reference to FIG. 2D may be practiced using the system (100) described in reference to FIG. 1A and the system (110) described in reference to FIGS. 1B and 1D, above, and/or involving the computing system (500) described in reference to FIG. 5A

Two or more propensity models are obtained at Step 262. Moreover, each propensity model extrapolates or models how data of a business entity relates to a particular type of future financial requirement of the business entity. For example, from the two or more propensity models, a first propensity model extrapolates or models how data of a business entity relates to a first type of future financial requirement, and a second propensity model extrapolates or models how the data of the business entity relates to a second type of future financial requirement.

In one or more embodiments, each propensity model may utilize a snapshot of a business entity at a current or prior time to determine that the business entity is likely to require a particular type of financing at some future point in time (e.g., in 3 months, 6 months, etc.). In one or more embodiments, each of the propensity models may include a propensity model that has been built according to the method (200) of FIG. 2A, described above. As an option, the two or more propensity models obtained at Step 262 may be generated according to the method (220) of FIG. 2B. Of course, the propensity models obtained at Step 262 may be generated by any other relevant method.

Next, at Step 264, data of a business entity is gathered. The data of the business entity may include financial data and/or metadata. In one or more embodiments, the data of the business entity matches at least a subset of the propensity models. For example, if a first propensity model of the two or more propensity models includes rules based on the geographic location and year-over-year revenue of the business entity, and a second propensity model of the two or more propensity models includes rules based on a number of items in the inventory of the business entity, then the data gathered at Step 264 includes the geographic location of the business entity, the yearly revenue of the business entity, and the number of items held in the inventory of the business entity.

Next, at Step 266, the business entity is scored by applying each of the two or more propensity models to the data of the business entity. In one or more embodiments, each of the propensity models includes numerous rules. Moreover, the rules of the propensity models may be based on financial aspects of the business entity and/or non-financial aspects of the business entity. In one or more embodiments, each of the propensity models may be expressed as different mathematical formulas, such that the application of a propensity model to the data of a business entity includes calculating a plurality of values and summing the values according to the formula of the model. For example, each rule of a given propensity model may be associated with a coefficient, each of the coefficients may be multiplied by a ‘0’ or a 1′ based on the data of the business entity, and the products may be summed. Also, the sum may be normalized or adjusted. For example, the sum may be adjusted so that it is between 0 and 1, or another pre-determined range. Thus, the score for a given propensity model may include the summation of the products, or may include a normalized or adjusted sum of the products. As a result of applying each of the two or more propensity models to the data of the business entity, two or more scores are obtained.

The scores of the business entity are compared at Step 268. Further, based on the comparison of the scores, a representative score is selected at Step 270. As an option, the scores may be compared to identify the greatest score or the smallest score of the scores. In one or more embodiments, the greatest or smallest score may be selected as the representative score of the business entity. For example, if a first score of 0.818 is obtained for a business entity from a first propensity model, and a second score of 0.612 is obtained for the business entity from a second propensity model, then the larger score of 0.818 may be selected as a representative score for the business entity. As described hereinabove, the first score may be representative of a future requirement of the business entity for a first type of financing, and the second score may be representative of a future requirement of the business entity for a second type of financing. Accordingly, by selecting a minimum or maximum score, the representative score may identify the type of financing that the business entity has the greatest likelihood of requiring in the near future.

Also, a classification of a future financial requirement of the business entity is generated, at Step 272, using the selected score of the business entity. In one or more embodiments, the classification of the future financial requirement of the business entity is based on a set of classification ranges that are associated with the propensity model used to calculate the selected score. For example, if a first score of 0.818 is obtained for a business entity from a first propensity model, and a second score of 0.612 is obtained for the business entity from a second propensity model, and the larger score of 0.818 is selected as a representative score for the business entity, then the classification of the future financial requirement of the business entity may be performed using a first set of classification ranges associated with the first propensity model. In this way, the classification of the business entity's future financial requirement may be sensitive to the particular set of classification ranges associated with the relevant propensity model. For example, a range of 0.700-0.900 may evidence a significant future financial requirement in relation to a first propensity model, but only a moderate future financial requirement in relation to a second propensity model.

In this manner, for each of the business entities scored by applying the two or more propensity models, and then selecting a representative score for the business entity, the business entity is classified based on its uniquely selected score.

In one or more embodiments, at Step 274, a process is initiated based on the classification of the future financial requirement of the business entity.

In one or more embodiments, the process initiated at Step 274 may include transmitting a message to the business entity, as described in the context of Step 250 of the method (240) of FIG. 2C. As described hereinabove, the message may include an email, a web page, or an advertisement. Accordingly, the transmission of the message includes any act of sending the message to the business entity in a targeted manner. As previously noted, the transmission may occur via a computer network and/or via physical correspondence.

In one or more embodiments, a content of a message transmitted at Step 274 may be based on the classification of the future financial requirement of the business entity. In other words, if business entities are classified into quartiles based on their selected scores, then all business entities in the top quartile of a given set of ranges may be transmitted messages containing the same, or similar, offers. For example, all business entities classified in the top quartile of a set of classification ranges associated with a propensity model for invoice financing may be offered invoice financing with interest rates between 3-7%.

In one or more embodiments, a method of transmission of a message transmitted at Step 274 may be based on the classification of the future financial requirement of the business entity. In other words, if business entities are classified into quartiles based on their selected scores, then all business entities in the top quartile of a given set of ranges may receive electronically transmitted messages (e.g., web page advertisements, emails, etc.), while any business entities classified in any of the other three quartiles of the set of ranges may receive physical correspondence (e.g., postcards, direct mailings, etc.), if any.

In one or more embodiments, the process initiated at Step 274 may include delaying or preventing the transmission of a message to the business entity. For example, if a first score of 0.618 is obtained for a business entity from a first propensity model, and a second score of 0.411 is obtained for the business entity from a second propensity model, then the larger score of 0.618 may be selected as a representative score for the business entity. Further, the classification of the future financial requirement of the business entity may be performed using a first set of classification ranges associated with the first propensity model. The selected score of 0.618 may fall into the second or third quartiles of the set of ranges associated with the first propensity model. As a result of falling into the second or third quartiles of the set of ranges associated with the first propensity model, the business entity may be determined to have a minimal or moderate future financial requirement for a type of financing that is associated with the first propensity model. For example, the business entity may be determined to have a minimal or moderate future financial requirement for invoice financing. As a result of the highest score output from the two or more propensity models failing to evidence a significant financial requirement of the business entity, the transmission of a message offering a financial product to the business entity may be prevented.

In one or more embodiments, a message may not be transmitted to the business entity until a classification of the future financial requirement of the business entity, based on a selected or representative score of the business entity, indicates that the business entity has a significant future financial requirement. As a result, limited resources may not be wasted on contacting business entities that have failed to show a threshold level of need for a particular type of financing.

In this way, each of a plurality of business entities may be transmitted a message offering a financial product that has been prioritized based on a classification of a future financial requirement of the business entity. Moreover, the future financial requirement of the business entity, upon which the offer is based, may be determined to be the most likely or significant future financial requirement of the business entity. As a result, those business entities determined to have the greatest financial need are contacted such that they can obtain financing in an efficient and timely manner, without risk of being forced into a high interest rate loan, or stunting the growth of their business. Further, each of the business entities may be presented with a targeted offer for financing that is representative of the most likely type of financing that the business entity will require in the future.

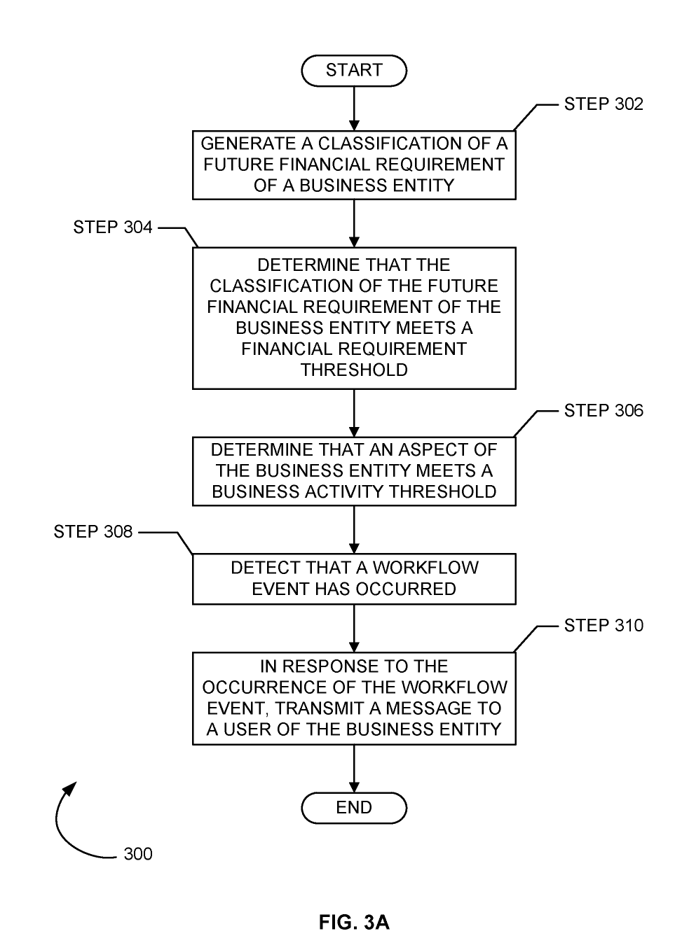

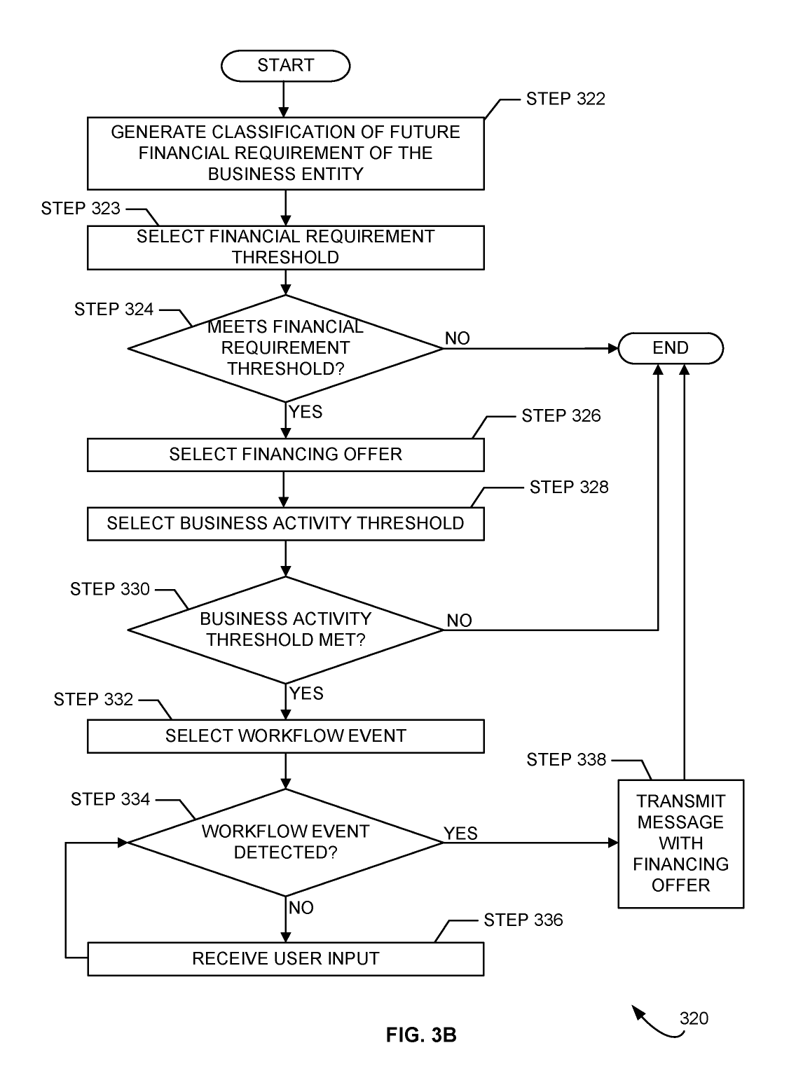

FIG. 3A depicts a flowchart of a method (300) for the workflow-driven transmission of a message to a user of a business entity based on propensity model scoring, in accordance with one or more embodiments of the invention. In one or more embodiments, one or more of the steps shown in FIG. 3A may be omitted, repeated, and/or performed in a different order. Accordingly, embodiments of the invention should not be considered limited to the specific arrangements of steps shown in FIG. 3A. In one or more embodiments, the method (300) described in reference to FIG. 3A may be practiced using the system (100) of FIG. 1A, the system (110) of FIGS. 1B, 1C, and 1D, or the computing system (500) of FIG. 5A, and be based on the methods described with respect to FIGS. 2A, 2B, 2C, and 2D.

At Step 302, a classification of a future financial requirement of a business entity is generated. In one or more embodiments, the classification of the future financial requirement of the business entity may be based on a score that is calculated by applying a propensity model to data of the business entity. For example, the classification of the future financial requirement of the business entity may be generated as described in the context of Steps 246-248 of the method (240) of FIG. 2C.

In one or more embodiments, the classification of the future financial requirement of the business entity may be based on a selected or representative score. For example, the representative score may be selected from two or more scores, where each of the scores have been calculated by applying a respective propensity model to the data of the business entity, as described in the context of Steps 266-270 of the method (260) of FIG. 2D.

In one or more embodiments, the classification of the future financial requirement may include determining the future financial requirement of the business entity relative to one or more other business entities. As an option, a score of the business entity may be classified into one or more ranges of values within which business entities are divided based on predicted future financial need. For example, numerous different business entities may be scored, and, based on the respective scores, classified into quartiles of financial need. Accordingly, classifying a future financial requirement of a business entity may include classifying the business entity as being in a first, second, third, or fourth quartile of requiring financing in the future.

Also, at Step 304, it is determined that the future financial requirement of the business entity meets a financial requirement threshold.

As noted, in one or more embodiments, the future financial requirement of the business entity may be classified into one of four quartiles. Further, a financial requirement threshold may be established based on the quartiles. In other words, the financial requirement threshold may include a minimum quartile.

In one or more embodiments, the financial requirement threshold may be established as the first quartile, second quartile, third quartile, or fourth quartile. For example, if the financial requirement threshold is set to be the third quartile, then any business entity with a future financial requirement classified in the first, second, or third quartile may be determined to meet the financial requirement threshold. As another example, if the financial requirement threshold is set to be the first quartile, then any business entity with a future financial requirement classified in the first quartile may be determined to meet the financial requirement threshold. In one or more embodiments, the financial requirement threshold may include a minimum value of the score used to classify the future financial requirement of the business entity. Accordingly, in such embodiments, a business entity with a score that is greater than or equal to the minimum value may be determined to meet the financial requirement threshold.

In addition, at Step 306, it is determined that an aspect of the business entity meets a business activity threshold. As described herein, the business activity threshold may include any measurable commercial aspect of business operation.

In one or more embodiments, the business activity threshold may be based on the quantification of one or more transactions of a business entity. As an option, the business activity threshold may require a minimum continued growth of the business entity, a minimum value of outstanding invoices of the business entity, and/or a minimum value of a single outstanding invoice of the business entity. For example, the business activity threshold may require that total invoices exceed a dollar amount (e.g., $1,000, $2,000, $10,000, etc.). As another example, the business activity threshold may require that the business entity has grown at a rate (e.g., 5%, 10%, 25%, etc.) per time period (e.g., month-over-month, year-over-year, etc.), for a minimum period of time (e.g., 6 months, 12 months, 6 years, etc.).

In one or more embodiments, the business activity threshold may require that the business entity have added one or more new employees, and/or have a minimum number of total employees. For example, the business activity threshold may require that the business entity has added a new employee to payroll, and now has five employees on payroll.

In one or more embodiments, the business activity threshold may require that one or more other businesses, or types of business, have been invoiced by the business entity. For example, the business activity threshold may require that the business entity has invoiced some minimum dollar amount to a pre-determined business, or a business included in a pre-determined list of businesses. The pre-determined list of businesses may include businesses selected for their creditworthiness, timeliness of payment, size, business rating, annual revenue, annual profit, credit score, or other quantitative metric. For example, the business activity threshold may require that the business entity have issued invoices to a particular well-established business (e.g., Wal-Mart or Home Depot), or that the business entity has issued some minimum dollar value of invoices (e.g., $10,000) to a business with over $100B in annual revenue.

Additionally, at Step 308, the occurrence of a workflow event is detected. As used herein, the workflow event includes any discrete user action or user activity occurring on a platform. Accordingly, in one or more embodiments, for the workflow event to be detected, a user associated with a business entity will be presently engaged with a platform. In one or more embodiments, the workflow event may include selection and/or viewing of an item by a user on a platform, such as a financial management platform. For example, the workflow event may include the viewing of payroll, a business health summary, business dashboard, or accounting information (e.g., cash flow, cash balances, annual revenue, year-over-year growth, etc.) by a user on a financial management platform.

In one or more embodiments, the workflow event may include the creation, modification, or closure of a transaction by a user on a platform. For example, the workflow event may include the creation of an invoice, marking an invoice as paid, etc. As an option, the transaction may be associated with a minimal value. For example, the workflow event may include the creation of an invoice with a minimum value of $500.

At Step 310, a message is transmitted to a user of the business entity in response to the occurrence of the workflow event. In one or more embodiments, the message is based on the classification of the future financial requirement of the business entity, an aspect of the business entity, and/or the detected workflow event. For example, the transmission of the message may proceed as described in the context of Step 250 of the method (240) of FIG. 2C.

Accordingly, a message including a financing offer may be transmitted to a user of a business entity, where the content of the message is customized based on the particular future financial requirement of the business entity. Moreover, the receipt of the message by the business entity is timed to ensure the most impactful response. In particular, the receipt of the message may be timed to coincide with the occurrence of user activities that relate to the content of the message, and/or recent business developments that may render obvious the value of business financing to the users of the business entity.

FIG. 3B depicts a flowchart of a method (320) of the workflow-driven transmission of a message to a user of a business entity based on propensity model scoring, in accordance with one or more embodiments of the invention. In one or more embodiments, one or more of the steps shown in FIG. 3B may be omitted, repeated, and/or performed in a different order. Accordingly, embodiments of the invention should not be considered limited to the specific arrangements of steps shown in FIG. 3B. In one or more embodiments, the method (320) described in reference to FIG. 3B may be practiced using the system (100) of FIG. 1A, the system (110) of FIGS. 1B, 1C, and 1D, or the computing system (500) of FIG. 5A, and be based on the methods described with respect to FIGS. 2A, 2B, 2C, and 2D.

At Step 322, a classification of a future financial requirement of a business entity is generated. In one or more embodiments, the classification of the future financial requirement of the business entity may be based on a score that is calculated by applying a propensity model to data of the business entity. For example, the classification of the future financial requirement of the business entity may be generated as described in the context of Step 302 of the method (300) of FIG. 3A.

Also, at Step 323, a financial requirement threshold is selected. In one or more embodiments, the financial requirement threshold may be pre-determined. For example, where numerous business entities are scored by a propensity model, the financial requirement threshold may be configured such that all business entities classified in the top 5%, 10%, 25%, 50%, etc. of financial need meet the financial requirement threshold.

In one or more embodiments, the financial requirement threshold may be selected based on a type of financing, such that different financial requirement thresholds are associated with different types of financing. For example, if a business entity is scored using a propensity model for invoice financing, and the classification of the future financial requirement of the business entity is based on the invoice financing propensity model score, the financial requirement threshold may be selected based the economic climate for invoice financing, the needs of other business entities with respect to invoice financing, special offers for invoice financing, etc. As another example, if a business entity is scored using a first propensity model for invoice financing, and a second propensity model for equipment financing, and the classification of the future financial requirement of the business entity is based on the equipment financing propensity model score, the financial requirement threshold may be based the economic climate for equipment financing, the needs of other business entities with respect to equipment financing, special offers for equipment financing, etc.

In one or more embodiments, the financial requirement threshold may be adjusted based on the time of year. For example, the financial requirement threshold may be lowered during some weeks, months, seasons, etc. This may increase the number of business entities that apply for a particular type of financing during a controlled period of time. As another option, the financial requirement threshold may be adjusted based on funds available to offer business entities. For example, as fewer funds become available for borrowing by businesses, the financial requirement threshold may be raised to ensure that future offers are targeted to those businesses with the greatest financial need.

In one or more embodiments, the financial requirement threshold selected at Step 323 may be selected based on an industry of the business entity. For example, for two business entities that have been scored using the same propensity model, the financial requirement threshold selected for the first business entity may be lower than the financial requirement threshold selected for the second business entity due to the different industries that the entities are in.

Accordingly, the financial requirement threshold selected at Step 323 may be based on the relevant business entity, a propensity model used to score the business entity, the industry of the business, and other external factors.

Also, at Step 324, it is determined whether the classification of the future financial requirement of the business entity meets the financial requirement threshold selected at Step 323. If the classification of the business entity does not meet the financial requirement threshold, then the method (320) of FIG. 3B ends.

However, if, at Step 324, the classification of the business meets the financial requirement threshold, then a financing offer is selected at Step 326. The financing offer may include any offer for a financial product. For example, the financing offer may include an offer for a business loan, a credit line, invoice financing, equipment financing, etc. In one or more embodiments, the financing offer may be selected from a pool of currently available offers from one or more different lenders.

In one or more embodiments, the financing offer may be selected based on the model that was used to generate a score for the business entity, where the score was used to classify the future financial requirement of the business entity. For example, if a business entity is scored using a propensity model for invoice financing, and the classification of the future financial requirement of the business entity is based on the invoice financing propensity model score, the selected financing offer may include an offer for invoice financing.

As another example, if a business entity is scored using a first propensity model for invoice financing and a second propensity model for equipment financing, and the score of the second propensity model is selected to be a representative score, then the classification of the future financial requirement of the business entity may be based on the equipment financing propensity model score. Accordingly, the financing offer selected at Step 326 may include an offer for equipment financing. In this manner, the financing offer selected at Step 326 may be effectively matched to the most probable future financial requirement of the business entity.

In one or more embodiments, the financing offer may be selected based on the classification of the future financial requirement of the business entity. As an option, the terms of the financing offer may be adjusted based on the classification of the future financial requirement of the business entity. For example, the interest rate of the financing offer may be adjusted higher or lower depending on the classification of the future financial requirement of the business entity.

Also, at Step 328, a business activity threshold is selected. As noted above, the business activity threshold may include any measurable commercial aspect of business operation. As an option, the business activity threshold may be selected to ensure that, if the business activity threshold is met, then business operations are trending in a positive manner, such that access to the financing offer selected at Step 326 is likely to ensure the continued growth of the business entity.

In one or more embodiments, the business activity threshold selected at Step 328 may be selected based on the financing offer, the financial requirement threshold, the classification of the future financial requirement of the business entity (e.g., significant need, moderate need, etc.), and/or the propensity model used to generate the score upon which the classification of the future financial requirement is based.

The business activity threshold may be selected based on the type of financing offer (e.g., invoice financing, credit line, equipment financing, etc.), and/or the terms of the financing offer (e.g., period of repayment, interest rate, collateral, etc.). More specifically, and as noted previously, if the score output by an invoice financing propensity model is used to classify the future financial requirement of the business entity, then the business activity threshold may include a minimum requirement directed to invoices of the business entity. For example, the business activity threshold may require that total invoices exceed a dollar amount (e.g., $1,000, $2,000, $10,000, etc.), or that a single invoice exceed a dollar amount. As another example, if the score output by an equipment financing propensity model is used to classify the future financial requirement of the business entity, then the business activity threshold may include a minimum value of asset depreciation. Moreover, in one or more embodiments, the minimum value or minimum requirement of the business activity threshold may depend on the financial requirement threshold selected at Step 323.

In one or more embodiments, the business activity threshold may be based on an industry of the business entity. For example, if the business activity threshold requires that a total value of invoices exceed a dollar amount, that dollar amount may be selected based on the industry of the business entity. As another example, if the business activity threshold requires a minimum year-over-year growth rate, that minimum year-over-year growth rate may be determined based on an industry of the business entity. As an option, some business activity thresholds may be unique to a specific industry.

At Step 330, a determination is made whether an aspect of the business entity meets the business activity threshold. The Step 330 may proceed as described in the context of Step 306 of the method (300) of FIG. 3A. For example, it may be determined, at Step 330, whether the business entity has grown at a minimum rate, has one or more invoices that total over a certain dollar amount, has a minimum number of employees on payroll, and/or is selling to customers with a minimum level of creditworthiness. If the business activity threshold is not met, then the method (320) ends.

However, if, at Step 330, a determination is made that the business activity threshold is met, then a workflow event is selected at Step 332. The workflow event may include any discrete user action or user activity occurring on a platform. For example, the workflow event may include the selection and/or viewing of an item by a user on a platform, such as a financial management platform. The item may include a tab, window, section, etc. As more specific examples, the workflow event may include the viewing of payroll, a business health summary, business dashboard, accounting information (e.g., cash flow, cash balances, annual revenue, year-over-year growth, etc.) by a user on a financial management platform.

In one or more embodiments, the workflow event selected at Step 332 may be selected based on the business activity threshold, the financing offer, the financial requirement threshold, and/or the propensity model used to generate the score upon which the classification of the future financial requirement is based.

For example, if the classification of the future financial requirement of the business entity is based on an invoice financing propensity model, then the workflow event selected at Step 332 may be related to invoices. More specifically, the workflow event may include the entry of invoices, the entry of an invoice having a minimum value, the entry of one or more invoices totaling a minimum value, the entry of one or more invoices totaling a minimal value to a customer of a particular level of creditworthiness, the viewing of invoices, etc.

In one or more embodiments, the workflow event selected at Step 332 may include viewing a report of account balances (e.g., a business checking account balance, etc.), a report of business income, and/or a report of business cash flow.

At Step 334, a determination is made whether the selected workflow event is detected. The determination at Step 334 may proceed as described in the context of Step 308 of the method (300) of FIG. 3A. If the workflow event is detected, then, at Step 338, a message is transmitted to a user of the business entity. The message contains the financing offer selected at Step 326. However, if the workflow event is not detected at Step 334, the method (320) may continue to receive user input, at Step 336, until the workflow event is detected at Step 334. For example, if the workflow event includes the entry of an invoice of a minimum value of $2,000, then a user associated with the business entity may continue to enter invoices until an invoice worth at least $2,000 is entered by the user, at which point the message is transmitted at Step 338. As another example, if the workflow event includes viewing the overall health of the business entity in a dashboard, then a user associated with the business entity may be transmitted the message with the financing offer only upon viewing the health of the business entity.

In this way, the content of a message providing a financing offer may be customized based on the particular future financial requirement of the business entity being provided the offer. Moreover, the transmission of a customized offer may be timed to ensure an optimal result for both the business entity and a lender associated with the offer. For example, the business activity threshold may be correlated to some minimum level of expected growth of the business entity. Further, the workflow event may be selected in a manner that ensures the message including the financing offer is delivered at a time when a user associated with the business entity is most likely to appreciate the positive impact such an offer may have. For example, an offer for financing may be best appreciated by a representative of a business while viewing a report of the health of the business, the value of outstanding invoices of the business, or the predicted cash flow of the business.

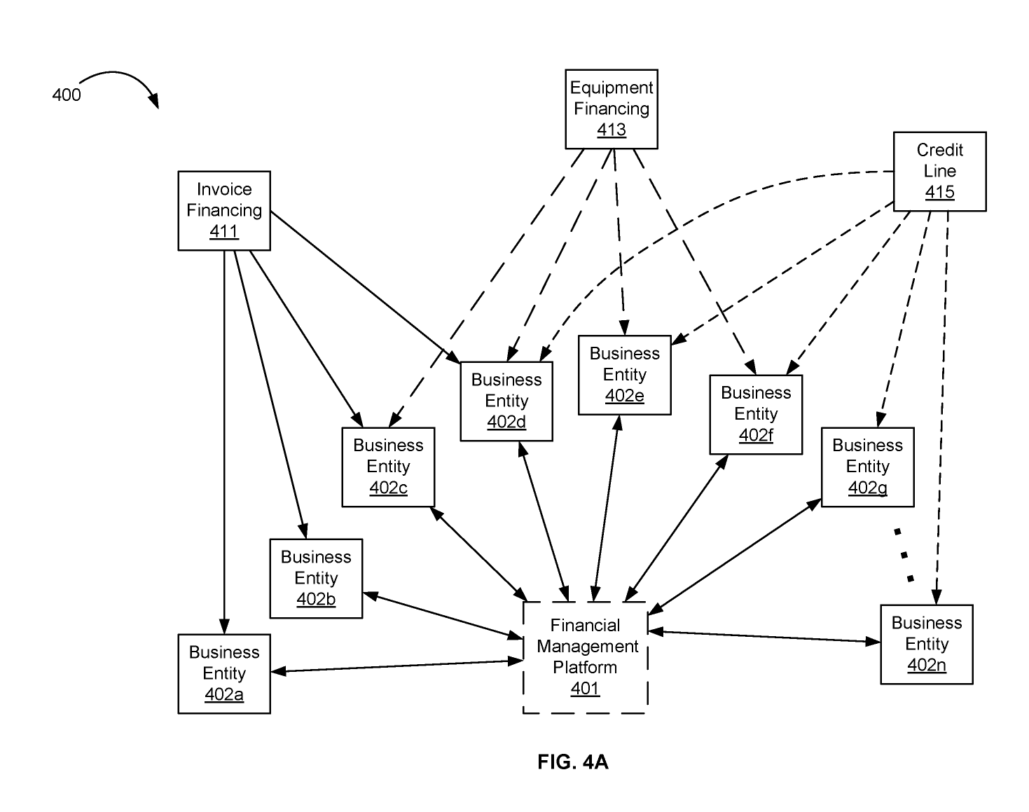

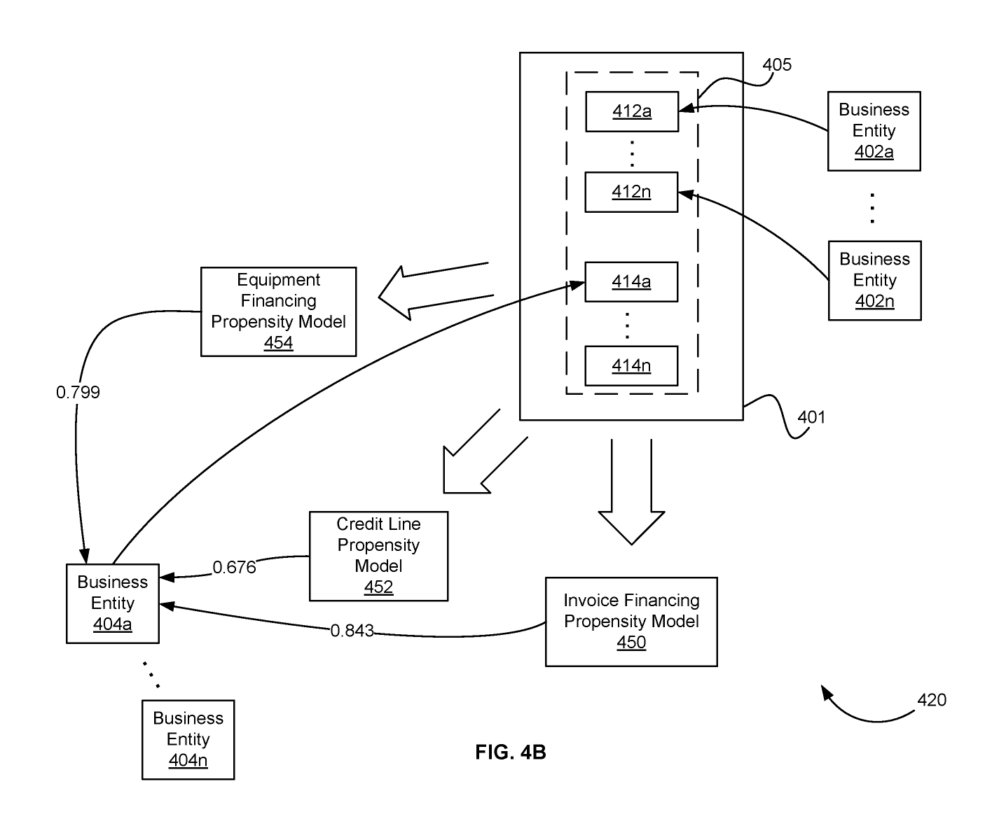

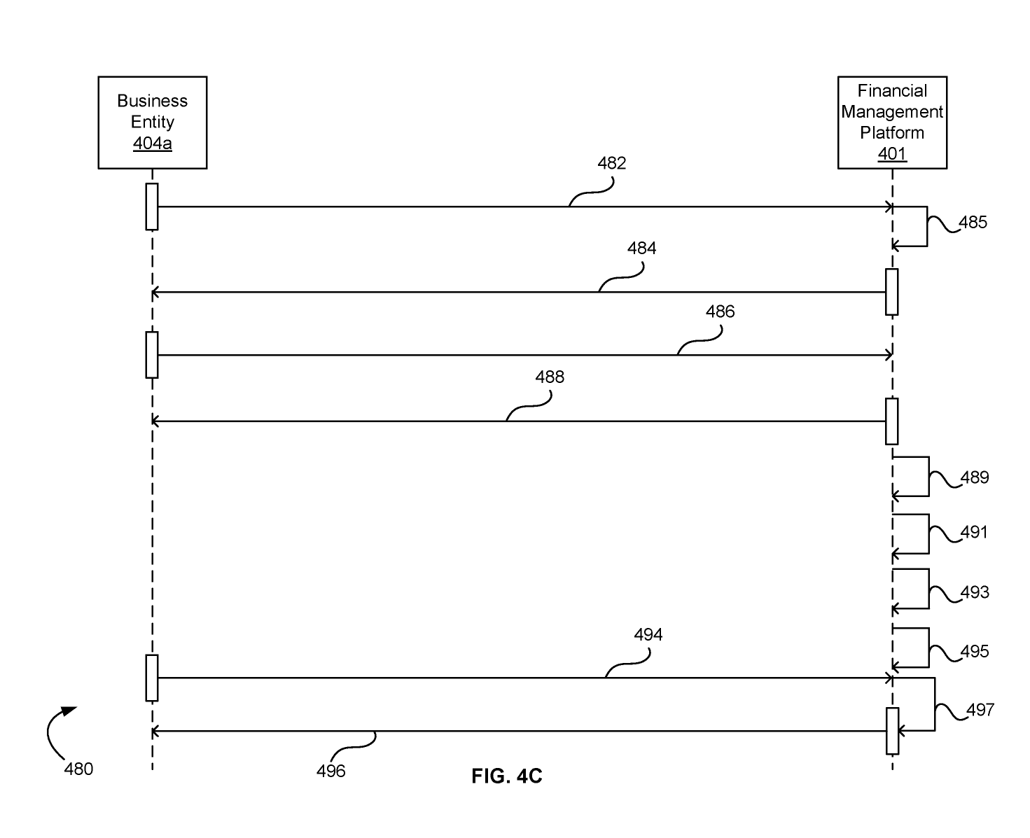

Referring now to FIGS. 4A, 4B, and 4C a system (400, 420) and communication flow (480) illustrate an example of applying multiple propensity models for identifying a future financial requirement of a business entity, and subsequently delivering a financing offer in response to the occurrence of a workflow event, in accordance with one or more embodiments of the invention. The exemplary system (400, 420) may be practiced using the system (100) of FIG. 1A, the financial requirement prediction system (110) of FIGS. 1B, 1C, and 1D, or the computing system (500) of FIG. 5A, and be based on the methods described with respect to FIGS. 2A, 2B, 2C, and 2D, as well as FIGS. 3A and 3B, above.

As shown in FIG. 4A, the system (400) includes a first plurality of business entities (402) interacting with a financial management platform (401). As described hereinabove, each of the business entities may include any person or company that is engaged in a commercial enterprise. Moreover, the financial management platform may be utilized by users associated with the business entities to operate the business entity with which the user is associated, such as, for example, by performing accounting functions, running payroll, calculating tax liabilities, billing customers, creating invoices, etc. More specific examples of financial management platforms include Intuit QuickBooks, Intuit TurboTax, etc. The financial management platform may be hosted on a production environment, such as the production environment (104) described in the context of the system (100) of FIG. 1A.

Still yet, as illustrated by FIG. 4A, each of the business entities (402a-402n) have received an offer for a particular type of financing. In particular, each of the business entities (402a-402n) has received at least one offer for invoice financing (411), equipment financing (413), and/or credit line (415). More specifically, an offer for invoice financing (411) has been provided to each of a first group of business entities (402a, 402b, 402c, 402d), an offer for equipment financing (413) has been provided to each of a second group of business entities (402c, 402d, 402e, 402f), and an offer for a credit line (415) has been provided to each of a third group of business entities (402d, 402e, 402f, 402g, 402n). The receipt of such offers by the different business entities (402), and their respective responses to the offers (i.e., initiating a financing process, no response, etc.), may be tracked by the financial management platform (401). For example, information identifying the receipt of the invoice financing offer (411) and the equipment financing offer (413) by a particular business entity (402d) may be stored in the financial management platform (401), as well as the response of the particular business entity (402d) to both offers. As an option, this information may be included in business entity data stored at the financial management platform (401).

For example, referring to FIG. 4B, the system (420) shows a financial management platform (401) storing account data (405). The account data (405) is shown to include first business entity data (412a) for a first business entity (402a), and second business entity data (412n) for a second business entity (402n). For purposes of simplicity and clarity, the following description is limited to describing the data of two business entities, however it is understood that the account data (405) may store data for hundreds, thousands, tens of thousands, or more business entities (402).

The first business entity data (412a) may include financial data and/or metadata associated with the first business entity (402a). Of particular relevance, the first business entity data (412a) includes a history of interaction of the first business entity (402a) with the financial management platform (401). For example, the first business entity data (412a) indicates that the first business entity (402a) began using the financial management platform (401) on a particular date, that the first business entity (402a) previously received an invoice financing offer (411) on another date, as well as if and when the first business entity (402a) responded to the invoice financing offer.

Similarly, the second business entity data (412n) may include financial data and/or metadata associated with the second business entity (402n). The second business entity data (412n) includes a history of interaction of the second business entity (402n) and the financial management platform (401). For example, the second business entity data (412n) indicates that the second business entity (402n) began using the financial management platform (401) on a particular date, that the second business entity (402n) previously received a credit line offer (415) on another date, as well as if and when the second business entity (402n) responded to the credit line offer.

Moreover, as shown in FIG. 4B, three propensity models (450, 452, 454) are built using the business entity data (412) of the various business entities (402), which indicates how the respective business entities (402) responded to prior offers for financing. For example, the invoice financing propensity model (450) may be built using the business entity data (412) of the first group of business entities (402a, 402b, 402c, 402d) previously provided the invoice financing offer (411). Similarly, the credit line propensity model (452) may be built using the business entity data (412) of the third group of business entities (402d, 402e, 402f, 402g, 402n) previously provided the credit line offer (415). Also, the equipment financing propensity model (454) may be built using the business entity data (412) of the second group of business entities (402c, 402d, 402e, 402f) previously provided the equipment financing offer (413).

For example, if a first business entity (402a) and second business entity (402b) showed an interest in the offer for invoice financing (411) by initiating finance applications, but a third business entity (402c) and fourth business entity (402d) did not initiate finance applications in response to receiving the invoice financing offer (411), then the first business entity (402a) and the second business entity (402b) may be classified into a first population of business entities that have shown interest in the invoice financing offer (411), while the third business entity (402c) and the fourth business entity (402d) may be classified into a second, different, population of business entities that have not shown interest in a received invoice financing offer (411).

Additionally, for each of the business entities (402) in one of the first or second populations, the data of the business entity (402) is reconstructed to create a snapshot of the business entity at a pre-determined time prior to when the business entity received its respective offer. For example, the first business entity data (412a) may be reconstructed to generate a snapshot representative of the first business entity (402a) three months prior to when it received the invoice financing offer (411). Similarly, data of the second business entity (402b) may be reconstructed to generate a snapshot representative of the second business entity (402b) three months prior to when it received the invoice financing offer (411). Also, data of the third business entity (402c), and the fourth business entity (402d) may be reconstructed to generate snapshots representative of the third business entity and fourth business entity, respectively, three months prior to when each received its corresponding offer for invoice financing (411). The reconstructed data for each of the business entities (402) includes financial data, metadata, etc. generated by the business entity (402) before its respective cutoff date (i.e., three months prior to receipt of the respective offer).

In this manner, the invoice financing propensity model (450) may be built using reconstructed data of the first group of business entities (402a, 402b, 402c, 402d), the credit line propensity model (452) may be built using reconstructed data of the third group of business entities (402d, 402e, 402f, 402g, 402n), and the equipment financing propensity model (454) may be built using reconstructed data of the second group of business entities (402c, 402d, 402e, 402f).

Furthermore, each of the propensity models (450, 452, 454) is built to include numerous rules that, in combination, can be used to score others business entities (404), where each score is representative of a future financial need of the respective business entity (404). Specifically, the invoice financing propensity model (450) includes the two rules set forth in Table 1, the credit line propensity model (452) includes the three rules set forth in Table 2, and the equipment financing propensity model (454) includes the two rules set forth in Table 3.

Each of the rules of Table 1 is defined by one or more conditions. Also, each of the rules of Table 1 is associated with a corresponding support value, coefficient, and importance value.

TABLE 1

| Rule | Support | Coefficient | Importance | Definition |
|---|---|---|---|---|
| 1 | 0.627 | −0.256 | 99.0 | YOY_SALES_GROWTH <=0.1135 |
| 2 | 0.189 | 0.843 | 90.4 | FIRST_CHARGE_DATE <=110 & |
| | | | | NUMBER_EMPLOYEES >4 & |
| | | | | OUTSTANDING_INVOICES_VALUE >50000 |

Each of the rules of Table 2 is defined by one or more conditions. Also, each of the rules of Table 2 is associated with a corresponding support value, coefficient, and importance value.

TABLE 2

| Rule | Support | Coefficient | Importance | Definition |
|---|---|---|---|---|
| 1 | 0.527 | −0.556 | 100.0 | YOY_SALES_GROWTH <=0.1925 |
| 2 | 0.089 | 0.843 | 86.4 | FIRST_CHARGE_DATE <=110 |
| 3 | 0.632 | 0.389 | 67.6 | ANNUAL_SALES_REVENUE >=60925 & |
| | | | | ANNUAL_SALES_REVENUE <3000000 |

Each of the rules of Table 3 is defined by one or more conditions. Also, each of the rules of Table 3 is associated with a corresponding support value, coefficient, and importance value.

TABLE 3

| Rule | Support | Coefficient | Importance | Definition |
|---|---|---|---|---|
| 1 | 0.627 | 0.356 | 100.0 | YOY_SALES_GROWTH <=0.1925 & |
| | | | | FIRST_CHARGE_DATE <=105 |
| 2 | 0.289 | 0.443 | 96.1 | NAICS_CODE_NOT_IN (‘22’, ‘11’, ‘85’, ‘72’) |

When applying each of the propensity models (450, 452, 454) to the data of a given business entity (404), the data of the business entity (404) is tested against the various rules defined by the respective propensity model (450, 452, 454). For example, as illustrated by Table 1, the first rule of the invoice financing propensity model (450) is defined by one condition. More specifically, the first rule of the invoice financing propensity model (450) includes a condition based on a year-over-year sales growth (i.e., YOY_SALES_GROWTH) of the business entity. As also illustrated by Table 1, the second rule of the invoice financing propensity model (450) is defined by three conditions. More specifically, the second rule of the invoice financing propensity model (450) includes a condition based on the first charge date (i.e., FIRST_CHARGE_DATE) of the business entity, a condition based on the number of employees (i.e., NUMBER_EMPLOYEES) of the business entity, and a condition based on the value of outstanding invoices of the business entity (i.e., OUTSTANDING_INVOICES_VALUE).

As noted above, a first charge date includes a past point in time that is identified as the beginning of a business relationship with the business entity, such as, for example, when the business entity began using the financial management platform (401).

As illustrated by Table 2, the first rule of the credit line propensity model (452) is defined by one condition. More specifically, the first rule of the credit line propensity model (452) includes a condition based on a year-over-year sales growth (i.e., YOY_SALES_GROWTH) of the business entity. Also, as illustrated by Table 2, the second rule of the credit line propensity model (452) is defined by one condition. More specifically, the second rule of the credit line propensity model (452) includes a condition based on the first charge date (i.e., FIRST_CHARGE_DATE) of the business entity. Still yet, as illustrated by Table 2, the third rule of the credit line propensity model (452) is defined by two conditions. Specifically, the third rule of the credit line propensity model is defined by two conditions directed to the annual sales revenue (i.e., ANNUAL_SALES_REVENUE) of the business entity.

As illustrated by Table 3, the first rule of the equipment financing propensity model (454) is defined by two conditions. More specifically, the first rule of the equipment financing propensity model (454) includes a condition based on a year-over-year sales growth (i.e., YOY_SALES_GROWTH) of the business entity, and a condition based on the first charge date (i.e., FIRST_CHARGE_DATE) of the business entity. Also, as illustrated by Table 3, the second rule of the equipment financing propensity model (454) is defined by one condition. More specifically, the second rule of the equipment financing propensity model (454) includes a condition based on the NAICS code (i.e., NAICS_CODE_NOT_IN) of the business entity.

As illustrated by FIG. 4B, each of the propensity models (450, 452, 454) are applied to business entity data (414a) of another business entity (404a) to predict a future financial requirement of the other business entity (404a). In particular, the invoice financing propensity model (450) is applied to the data (414a) of the other business entity (404a) to determine whether the other business entity (404a) is likely to need invoice financing. Similarly, the credit line propensity model (452) is applied to the data (414a) of the other business entity (404a) to determine whether the other business entity (404a) is likely to need a credit line, and the equipment financing propensity model (454) is applied to the data (414a) of the other business entity (404a) to determine whether the other business entity (404a) is likely to need equipment financing

Using the business entity data (414a) of the other business entity (404a), it is determined that the other business entity (404a) began using the financial management platform (401) 102 days ago. Moreover, and as reflected in the data (414a) of the other business entity (404a), the other business entity (404a) is a construction company, which is attributed a NAICS code of 23, and has sold $286,000 worth of services and products this year, which accounts for a 17% year-over-year sales growth. Of the $286,000 in revenue, $51,000 remains unpaid on outstanding invoices. Finally, the other business entity (404a) currently has five employees.

Accordingly, because the 17% year-over-year sales growth of the other business entity (404a) fails to meet the <=11.35% year-over-year sales growth condition of rule 1 of the invoice financing propensity model (450), a value of 0 is multiplied by the coefficient of rule 1 of the invoice financing propensity model (450), −0.256. Also, because the first charge date of 102 days of the other business entity (404a) meets the <=110 days first charge date condition of rule 2 of the invoice financing propensity model (450), the five employees working for the other business entity (404a) meets the number of employees condition of rule 2 of the invoice financing propensity model (450), and the $51,000 of outstanding invoices meets the outstanding invoices value condition of rule 2 of the invoice financing propensity model (450), a value of 1 is multiplied by the coefficient of rule 2 of the invoice financing propensity model (450), 0.843. Further, each of these products is added together to arrive at a sum of 0.843 (0+0.843).

Similarly, because the 17% year-over-year sales growth of the other business entity (404a) meets the <=19.25% year-over-year sales growth condition of rule 1 of the credit line propensity model (452), a value of 1 is multiplied by the coefficient of rule 1 of the credit line propensity model (452), −0.556. Also, because the first charge date of 102 days of the other business entity (404a) meets the <=110 days first charge date condition of rule 2 of the credit line propensity model (452), a value of 1 is multiplied by the coefficient of rule 2 of the credit line propensity model (452), 0.843. Still yet, because the $286,000 worth of yearly revenue meets the two annual sales revenue conditions of rule 3 of the credit line propensity model (452), a value of 1 is multiplied by the coefficient of rule 3 of the credit line propensity model (452), 0.389. Further, each of these products is added together to arrive at a sum of 0.676 (−0.556+0.843+0.389).

Because the 17% year-over-year sales growth of the other business entity (404a) meets the <=19.25% year-over-year sales growth condition of rule 1 of the equipment financing propensity model (454), and the first charge date of 102 days of the other business entity (404a) meets the <=105 days first charge date condition of rule 1 of the equipment financing propensity model (454), a value of 1 is multiplied by the coefficient of rule 1 of the equipment financing propensity model (454), 0.356. Also, because the other business entity (404a) is attributed a NAICS code of 23, it meets the NAICS code condition of rule 2 of the equipment financing propensity model (454), and a value of 1 is multiplied by the coefficient of rule 2 of the equipment financing propensity model (454), 0.443. Further, each of these products is added together to arrive at a sum of 0.799 (0.356+0.443).

In one or more embodiments, each of the sums may be considered to be a score of the other business entity (404a), as output from the respective propensity model (450, 452, 454). For example, the invoice financing propensity model (450) may calculate a score of 0.843 for the other business entity (404a), the credit line propensity model (452) may calculate a score of 0.676 for the other business entity (404a), and the equipment financing propensity model (454) may calculate a score of 0.799 for the other business entity (404a).

In one or more embodiments, the sums may be normalized or otherwise adjusted to arrive at the respective scores for the other business entity (404a). For example, sums output by the invoice financing propensity model (450) may be coordinately adjusted to ensure that all invoice financing propensity scores for the business entities (404) are within a given range, such as, for example, between 0 and 1, between 1 and 100, etc. Similarly, sums output by the credit line propensity model (452) or the equipment financing model (454) may be coordinately adjusted to ensure that all credit line propensity scores or equipment financing propensity scores, respectively, for the business entities (404) are within a given range, such as, for example, between 0 and 1, between 1 and 100, etc.

In one or more embodiments, the scores output by the propensity models (450, 452, 454) for the other business entity (404a) may be compared. Moreover, based on the comparison, a representative score for the other business entity (404a) may be selected. For example, the score of 0.843 from the invoice financing propensity model (450) may be selected as a representative score of the other business entity (404a) because it is greater than the score of 0.799 from the equipment financing propensity model (454) and the score of 0.676 from the credit line propensity model (452).

Based on the selected score of 0.843, the other business entity (404a) may be classified as likely to need invoice financing. Accordingly, the other business entity (404a) may be transmitted a message offering to help with a future invoice financing requirement of the other business entity (404a). For example, the other business entity (404a) may receive a targeted email, electronic advertisement, postcard, direct mailing, etc. based on its need for invoice financing. Moreover, the message may be transmitted to the other business entity (404a) after the occurrence of a workflow event.

Referring now to FIG. 4C, a communication flow (480) is illustrated in the context of the system (400, 420) of FIGS. 4A and 4B. In particular, an initial request (482) is received at the financial management platform (401) from a user of the other business entity (404a). In one or more embodiments, the initial request (482) may include a login from the user, a wake from idle state, or a navigation action. Moreover, the initial request (482) includes a request for resources, such as a particular webpage, tab, object, or portal.

Responsive to the initial request (482), the financial management platform (401) transmits a response (484) including the requested resources to the other business entity (404a). In addition, upon receiving the initial request (482), the financial management platform (401) generates a classification of the future financial requirement of the other business entity (404a). As described herein, the classification of the future financial requirement of the other business entity (404a) occurs as set forth above with respect to FIG. 4B, however it is understood that the classification of the future financial requirement of the other business entity (404a) may occur as described relative to the financial requirement prediction system (110) of FIGS. 1B, 1C, and 1D, and be based on the methods described with respect to FIGS. 2A, 2B, 2C, and 2D, as well as FIGS. 3A and 3B, above.

In particular, during a classification operation (485), the financial management platform (401) classifies the future financial requirement of the other business entity (404a) by scoring the other business entity using the propensity models (450, 452, 454), and selects a representative score from the three different scores. More specifically, during the classification operation (485) the score of 0.843 from the invoice financing propensity model (450) is selected as the representative score for the other business entity (404a).

Accordingly, between the initial request (482) and the response (484), a user of the other business entity (404a) has requested and received a resource of the financial management platform (401). At this point the user may be viewing a page that provides information regarding employees, vendors, inventory, banking, etc. of the business entity. Also, at this point, a future financial requirement of the other business entity (404a), for at least one particular type of financing, has been determined. Subsequently, the user of the business entity (404a) may interact with the financial management platform (401). This interaction may include the transmission of additional requests (486) from the other business entity (404a) to the financial management platform (401), which responds in turn by providing responses (488) to the additional requests (486). The additional requests (486) and corresponding responses (488) may represent any business management activity on the financial management platform (401). For example, the user may be requesting resources to view or enter transactions, to view of modify payroll, to view or modify inventory, to balance accounts, etc.

As the user of the business entity (404a) interacts with the financial management platform (401), the financial management platform (401), at a first operation (489), selects a financial requirement threshold, and determines whether the business entity (404a) meets the financial requirement threshold. The selection of the financial requirement threshold, and the subsequent determination, may proceed as described in the context of Steps 323-324 of the method (320) of FIG. 3B. For example, the financial management platform (401) may select a financial requirement threshold that is associated with the invoice financing propensity model (450) used to calculate the score of 0.843 and classify the future financial requirement of the other business entity (404a). In particular, during the first operation (489), the financial management platform (401) determines that the other business entity (404a) is in the first quartile of scores of the invoice financing propensity model (450), and has met a financial requirement threshold that requires a minimum of a classification in the second quartile.

Moreover, at a second operation (491) a financing offer is selected. The financing offer may be selected as described in the context of Step 326 of the method (320) of FIG. 3B. As an option, at the second operation (491), an offer for invoice financing is selected based on the use of the invoice financing propensity model (450) to determine the future financial requirement of the other business entity (404a). In particular, during the second operation (491), and offer for invoice financing is selected.

Additionally, at a third operation (493), a business activity threshold is selected, and then tested to determine whether the business activity threshold is satisfied by the other business entity (404a). The selection of the business activity threshold at the third operation (493), and the subsequent determination, may proceed as described in the context of Steps 328-330 of the method (320) of FIG. 3B. The business activity threshold may be selected based on the financing offer, the financial requirement threshold, the classification of the future financial requirement of the business entity (e.g., significant need, moderate need, etc.), an industry of the business entity, and/or the propensity model used to generate the score upon which the classification of the future financial requirement is based.

In particular, during the third operation (493), a business activity threshold is selected that requires at least $4,000 in outstanding invoices with at least $2,000 of the $4,000 addressed to companies with greater than $1B in annual revenue and a commercial credit score of at least 600. Based on the $51,000 of outstanding invoices of the other business entity (404a), and the customers that received those invoices, it is determined during the third operation (493) that the other business entity (404a) meets the selected business activity threshold.

Still yet, during a fourth operation (495), the financial management platform (401) selects a workflow event. The workflow event may be selected based on the financing offer, the financial requirement threshold, the classification of the future financial requirement of the business entity (e.g., significant need, moderate need, etc.), an industry of the business entity, the business activity threshold, and/or the propensity model used to generate the score upon which the classification of the future financial requirement is based. In particular, the workflow event selected during the fourth operation (495) requires that a user of the other business entity (404a) view a dashboard presenting an expected cash flow of the other business entity (404a).

Accordingly, when the user of the other business entity (404a) issues a request (494) to view a dashboard displaying a health of the other business entity (404a), the financial management platform (401) determines, at a fifth operation (497), that the expected cash flow of the other business entity (404a) is included in the dashboard. Accordingly, the selected workflow event is satisfied. In response to the workflow event being satisfied, a message containing the offer is transmitted with the resources for the dashboard in a response (496) from the financial management platform (401) to the other business entity (404a). In particular, in addition to the dashboard requested by the user of the other business entity (404a), the response (496) includes a message presenting the invoice financing offer selected during the second operation (491). The message may include a customized webpage, an image, an alert, etc.

In this way, a financing offer may be selected based on the particular need of a business entity. Moreover, the delivery the financing offer may be delayed until 1) the business entity has objectively evidenced trends indicative of continued commercial success, and 2) a user of the business entity is in a position to appreciate that accepting such a financing offer may be important, or even necessary, for the continued growth of the business.

As a result, users or customers of a platform that are most in need of financing may be identified based on their financial data and metadata. Moreover, by identifying business trends utilizing a propensity model, the users or customers may be targeted with compelling financing offers before they find themselves in an inconvenient or detrimental position. In one or more embodiments, the financing offers they are provided may be customized to identify a particular type of financing that is likely to offer the greatest benefit. For example, by identifying the financial need of a business entity long before the owner of the business entity has realized the need, and by providing an enticing offer, the owner may begin early the process of applying for a low interest rate business loan, and avoid the pitfalls of a higher interest rate or short-term loan.

By offering a particular type of financing to the business entity based on the likely needs of the business entity, the owner of the business entity may not waste time reviewing different types of financing that are not relevant to his or her business. Moreover, by offering a particular type of financing to the business entity based on the likely needs of the business entity, the business entity may be more likely to obtain financing with terms that are appropriate for its particular needs.

Embodiments of the invention may be implemented on a computing system. Any combination of mobile, desktop, server, router, switch, embedded device, or other types of hardware may be used. For example, as shown in FIG. 5A, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include and/or perform all or a portion of one or more embodiments of the invention.

The computing system or group of computing systems described in FIGS. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file.

The computing system in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The above description of functions present only a few examples of functions performed by the computing system of FIG. 5A and the nodes and/or client device in FIG. 5B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
generating, based on a propensity model score of a business entity, a classification of a future financial requirement of the business entity;
determining that the classification of the future financial requirement of the business entity meets a financial requirement threshold;
determining, using data of the business entity, that an aspect of the business entity meets a business activity threshold;
detecting that a workflow event has occurred on a platform utilized by the business entity; and
in response to the determination that the workflow event has occurred, transmitting a message to a user of the business entity.

2. The method of claim 1, further comprising:
obtaining the propensity model, wherein the propensity model models how the data of the business entity relates to the future financial requirement of the business entity;
gathering the data of the business entity, wherein the data is created based on the platform utilized by the business entity, and the data of the business entity matches at least a subset of the propensity model; and
calculating the propensity model score for the business entity by applying the propensity model to the data of the business entity.

3. The method of claim 1, wherein the financial requirement threshold includes a minimum quartile of the future financial requirement of the business entity.

4. The method of claim 1, wherein the business activity threshold includes a minimum value of outstanding invoices of the business entity.

5. The method of claim 1, wherein the business activity threshold includes a minimum value of a single outstanding invoice of the business entity.

6. The method of claim 1, wherein the business activity threshold includes a growth rate of the business entity.

7. The method of claim 1, further comprising:
obtaining at least two propensity models, wherein each propensity model, of the at least two propensity models, models how the data of a business entity relates to the future financial requirement of the business entity;
gathering the data of the business entity, wherein the data is created based on the platform utilized by the business entity, and the data of the business entity matches at least a subset of each of the propensity models;
calculating at least two scores for the business entity by:
for each propensity model of the at least two propensity models, scoring the business entity by applying the propensity model to the data of the business entity to obtain a score for the business entity;
comparing the at least two scores for the business entity; and
based on the comparison of the at least two scores for the business entity, selecting a representative score from the at least two scores as the propensity model score of the business entity.

8. The method of claim 7, wherein each propensity model of the at least two propensity models is associated with a different future financial requirement.

9. The method of claim 8, wherein:
a first propensity model, of the at least two propensity models, models how the data of the business entity relates to a first future financial requirement of the business entity; and
a second propensity model, of the at least two propensity models, models how the data of the business entity relates to a second future financial requirement of the business entity that is different than the first future financial requirement of the business entity.

10. A system, comprising:
a hardware processor and memory; and
software instructions stored in the memory and configured to execute on the hardware processor, which, when executed by the hardware processor, cause the hardware processor to:
generate, based on a propensity model score of a business entity, a classification of a future financial requirement of the business entity,
determine that the classification of the future financial requirement of the business entity meets a financial requirement threshold,
determine, using data of the business entity, that an aspect of the business entity meets a business activity threshold,
detect that a workflow event has occurred on a platform utilized by the business entity, and
in response to the determination that the workflow event has occurred, transmit a message to a user of the business entity.

11. The system of claim 10, further including software instructions stored in the memory and configured to execute on the hardware processor, which, when executed by the hardware processor, cause the hardware processor to:
obtain the propensity model, wherein the propensity model models how the data of the business entity relates to the future financial requirement of the business entity,
gather the data of the business entity, wherein the data is created based on the platform utilized by the business entity, and the data of the business entity matches at least a subset of the propensity model, and
calculate the propensity model score for the business entity by applying the propensity model to the data of the business entity.

12. The system of claim 10, wherein the financial requirement threshold includes a minimum quartile of the future financial requirement of the business entity.

13. The system of claim 10, wherein the business activity threshold includes a minimum value of outstanding invoices of the business entity.

14. The system of claim 10, wherein the business activity threshold includes a minimum value of a single outstanding invoice of the business entity.

15. The system of claim 10, wherein the business activity threshold includes a growth rate of the business entity.

16. The system of claim 10, further including software instructions stored in the memory and configured to execute on the hardware processor, which, when executed by the hardware processor, cause the hardware processor to:
obtain at least two propensity models, wherein each propensity model, of the at least two propensity models, models how the data of a business entity relates to the future financial requirement of the business entity,
gather the data of the business entity, wherein the data is created based on the platform utilized by the business entity, and the data of the business entity matches at least a subset of each of the propensity models,
calculate at least two scores for the business entity by:
for each propensity model of the at least two propensity models, scoring the business entity by applying the propensity model to the data of the business entity to obtain a score for the business entity,
compare the at least two scores for the business entity, and
based on the comparison of the at least two scores for the business entity, select a representative score from the at least two scores as the propensity model score of the business entity.

17. The system of claim 16, wherein each propensity model of the at least two propensity models is associated with a different future financial requirement.

18. The system of claim 17, wherein:
a first propensity model, of the at least two propensity models, models how the data of the business entity relates to a first future financial requirement of the business entity; and
a second propensity model, of the at least two propensity models, models how the data of the business entity relates to a second future financial requirement of the business entity that is different than the first future financial requirement of the business entity.

19. A non-transitory computer readable medium storing instructions, the instructions, when executed by a computer processor, comprising functionality for:
generating, based on a propensity model score of a business entity, a classification of a future financial requirement of the business entity;
determining that the classification of the future financial requirement of the business entity meets a financial requirement threshold;
determining, using data of the business entity, that an aspect of the business entity meets a business activity threshold;
detecting that a workflow event has occurred on a platform utilized by the business entity; and
in response to the determination that the workflow event has occurred, transmitting a message to a user of the business entity.

20. The non-transitory computer readable medium of claim 19, wherein the instructions, when executed by the computer processor, further comprise functionality for:
obtaining the propensity model, wherein the propensity model models how the data of the business entity relates to the future financial requirement of the business entity;
gathering the data of the business entity, wherein the data is created based on the platform utilized by the business entity, and the data of the business entity matches at least a subset of the propensity model; and
calculating the propensity model score for the business entity by applying the propensity model to the data of the business entity.

21. The non-transitory computer readable medium of claim 19, wherein the financial requirement threshold includes a minimum quartile of the future financial requirement of the business entity.

22. The non-transitory computer readable medium of claim 19, wherein the business activity threshold includes a minimum value of outstanding invoices of the business entity.

23. The non-transitory computer readable medium of claim 19, wherein the business activity threshold includes a minimum value of a single outstanding invoice of the business entity.

24. The non-transitory computer readable medium of claim 19, wherein the business activity threshold includes a growth rate of the business entity.

25. The non-transitory computer readable medium of claim 19, wherein the instructions, when executed by the computer processor, further comprise functionality for:
obtaining at least two propensity models, wherein each propensity model, of the at least two propensity models, models how the data of a business entity relates to the future financial requirement of the business entity;
gathering the data of the business entity, wherein the data is created based on the platform utilized by the business entity, and the data of the business entity matches at least a subset of each of the propensity models;
calculating at least two scores for the business entity by:
for each propensity model of the at least two propensity models, scoring the business entity by applying the propensity model to the data of the business entity to obtain a score for the business entity;
comparing the at least two scores for the business entity; and
based on the comparison of the at least two scores for the business entity, selecting a representative score from the at least two scores as the propensity model score of the business entity.

26. The non-transitory computer readable medium of claim 25, wherein each propensity model of the at least two propensity models is associated with a different future financial requirement.
